(19) United States
(12) Patent Application Publication
(10) Pub. No.: US 2025/0045637 A1
(43) Pub. Date: Feb. 6, 2025

(54) SYSTEMS AND METHODS FOR PERFORMING SITUATION-AWARE CONTROL SYSTEM MODEL UPDATES

(71) Applicant: 3Laws Robotics Inc., Pasadena, CA (US)

(72) Inventors: Andrew W. Singletary, Pasadena, CA (US); Thomas Gurriet, Pasadena (FR)

(21) Appl. No.: 18/914,883

(22) Filed: Oct. 14, 2024

Related U.S. Application Data
(63) Continuation of application No. PCT/US23/72532, filed on Aug. 20, 2023.
(60) Provisional application No. 63/516,839, filed on Jul. 31, 2023.

(51) Int. Cl. G06N 20/00

(52) U.S. Cl. CPC G06N 20/00

(57) ABSTRACT

Methods and systems for parsimoniously updating cyber-system models based on then-current conditions. A wide variety of cyber-physical system models are deployed for ensuring that a system operates within its constraints while nevertheless achieving an assigned mission. Updating models is resource intensive, and thus should be done only when a particular degree of accuracy of a model is needed. Modern cyber-physical systems comprise sensors, transducers, and actuators that interoperate to carry out specific cyber-physical system behaviors. A control invariant barrier function (CBF) implements safety constraints that relate environmental parameters to safe behaviors of the cyber-physical system. Responsive to detected changes in the environment, a model update activity corresponding detected changes in the environment is initiated, but only when the result of such a model update impacts safe and/or mission-critical operation of the cyber-physical system. Invocation of model updates that would not impact safe operation of the cyber-physical system are suppressed.

### RELATED APPLICATIONS

The present application claims the benefit of priority to Application Ser. No. PCT/US23/72532 titled “ROBOTIC SIGNAL SUPERVISOR FOR SAFETY GUARANTEES” filed on Aug. 20, 2023, which is hereby incorporated by reference in its entirety.

### TECHNICAL FIELD

This disclosure relates to robotics, and more particularly to techniques for systems and methods for performing situation-aware control system model updates.

### BACKGROUND

Many robotic systems operate on the basis of mathematical models that describe the robotic system itself (e.g., how actuators behave in the real world, how sensors behave in the real world, etc.). Highly accurate robotic motions can be carried out based on commands issued from a user or from a computing module. For example, if a user or computing module turns a steering wheel two degrees clockwise, then the robot will actuate a steering mechanism to move the front wheels a commensurate amount. The aforementioned commensurate amount is calculated by the model. Continuing this example, if the user or computing module command the robot to turn right until a new course is set that is 2 degrees to the right of the current course, then (for example) the pinion of the rack and pinion steering mechanism would need to be rotated (for example) one and one half revolutions clockwise. In this case, the model takes as an input the steering control variation (e.g., turning) and outputs a number of revolutions (or fraction thereof) to turn the pinion. The model will take into account as much as is modellable about the physical characteristics of a rack-and-pinion steering system as a whole (e.g., the size of the gear of the pinon that slides the rack, the physical linkage between the rack and the steering tie rods, etc.).

In some cases, such a model, once calibrated for accuracy, does not change. At least it does not change quickly, possibly only changing in minute amounts due to wear-and-tear. In other cases, a model changes frequently and dramatically in real-time. For example, a model of a physical system that might produce an output based on a given input might be perfect when the physical system is being operated in a room temperature environment. However, the model might be a little “off” in the event that the physical system is being operated in a sub-zero degrees environment. In some cases, such a model can take into account (i.e., model) variations in temperature, whereas in other cases, the model needs to be modified (e.g., updated) to reflect environmental conditions. In this latter case, when environmental conditions change, the model needs to be updated accordingly. Moreover, for accuracy sake, the model would need to be updated at least as frequently as the environmental conditions are changing.

One approach that has been used in legacy systems is to update the model at a sufficiently high rate such that the model never outputs a value that is outside of a given accuracy or variance threshold.

Unfortunately, updating a model involves use of non-zero amounts of computing resources (e.g., MIPS), and unfortunately updating a model introduces a non-zero amount of delay time, during which delay time the model is either wrong or during which delay time the model is temporarily unavailable for modeling calculations. As such, a brute force approach involving high-rate model updates has serious unwanted side effects. On the other hand, failing to update the model with sufficient frequency leads to inaccuracies with respect to inputs (for a desired response) versus the behavior actually produced. This is strongly eschewed as this can lead to unintended and sometimes unsafe behaviors of the robot. There is a need to address these deficiencies.

The problem to be solved is therefore rooted in various technological limitations of legacy approaches. Improved technologies are needed. In particular, improved applications of technologies are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for systems and methods for performing situation-aware control system model updates, which techniques advance the relevant technologies to address technological issues with legacy approaches. More specifically, the present disclosure describes techniques used in systems, methods, and in computer program products for performing situation-aware control system model updates. Certain embodiments are directed to technological solutions for carrying out a just-in-time model update protocol.

The disclosed embodiments modify and improve beyond legacy approaches. In particular, the herein-disclosed techniques provide technical solutions that address the technical problems attendant to the frequency and nature of model updates that greatly impact safe operation of robotic systems. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication.

For example, when performing computer operations that address the various technical problems underlying the frequency and nature of model updates, both memory usage and CPU cycles demanded are significantly reduced as compared to the memory usage and CPU cycles that would be needed but for practice of the herein-disclosed techniques for carrying out a just-in-time model update protocol. Strictly as one case, the data structures as disclosed herein and their use serve to reduce both memory usage and CPU cycles as compared to alternative approaches. Moreover, information that is received during operation of the embodiments is transformed by the processes that store data into and retrieve data from the aforementioned data structures.

The ordered combination of steps of the embodiments serve in the context of practical applications that perform steps for carrying out a just-in-time model update protocol more efficiently. As such, these techniques overcome long-standing yet heretofore unsolved technological problems associated with the frequency and nature of model updates that arise in the realm of computer systems.

Many of the herein-disclosed embodiments for carrying out a just-in-time model update protocol are technological solutions pertaining to technological problems that arise in the hardware and software arts that underlie any sort of digital control system. Aspects of the present disclosure achieve performance and other improvements in peripheral technical fields including, but not limited to, robotic control systems and ultra-safe robotic system actuator design.

Some embodiments include a sequence of instructions that are stored on a non-transitory computer readable medium. Such a sequence of instructions, when stored in memory and executed by one or more processors, causes the one or more processors to perform a set of acts for carrying out a just-in-time model update protocol.

Some embodiments include the aforementioned sequence of instructions that are stored in a memory, which memory is interfaced to one or more processors such that the one or more processors can execute the sequence of instructions to cause the one or more processors to implement acts for carrying out a just-in-time model update protocol.

In various embodiments, any combinations of any of the above can be organized to perform any variation of acts for performing situation-aware control system model updates, and many such combinations of aspects of the above elements are contemplated.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1A1 depicts a model transformation technique as used in systems that perform situation-aware control system model updates, according to an embodiment.

FIG. 1A2 depicts a control invariant model having a control barrier function, according to an embodiment.

FIG. 1B1 depicts a table-implemented behavioral model as used in systems that perform situation-aware control system model updates, according to an embodiment.

FIG. 1B2 depicts a code-implemented behavioral model instance as used in systems that perform situation-aware control system model updates, according to an embodiment.

FIG. 1C is a risk impact chart showing multiple risk impact regimes that correspond to just-in-time digital control system model update scheduling techniques, according to an embodiment.

FIG. 1D1 is an environmental data gathering demand predictor as used when implementing control invariant models, according to an embodiment.

FIG. 1D2 is a compute resource demand predictor as used when implementing control invariant models, according to an embodiment.

FIG. 2A is a flowchart depicting a just-in-time digital control system model update scheduling technique, according to an embodiment.

FIG. 2B exemplifies an operating environment depicting a scenario where just-in-time digital control system model update scheduling technique can be advantageously applied, according to an embodiment.

FIG. 3A depicts an example cyber-physical system configuration for implementing just-in-time digital control system model update scheduling, according to an embodiment.

FIG. 3B depicts an example update candidate determination technique as used to implement just-in-time digital control system model updates, according to an embodiment.

FIG. 4 depicts system components as arrangements of computing modules that are interconnected so as to implement certain of the herein-disclosed embodiments.

FIG. 5A depicts a block diagram of an instance of a computer system suitable for implementing embodiments of the present disclosure.

FIG. 5B depicts an environment in which a behavior guarantee module can be implemented.

FIG. 5C1 depicts a block diagram of an interstitially situated supervisory layer, in accordance with some implementations.

FIG. 5C2 depicts a block diagram involving a human operator's safe manipulation of a robotic control system, in accordance with some implementations.

FIG. 5D depicts a safe signal generation technique, in accordance with some implementations.

### DETAILED DESCRIPTION

Aspects of the present disclosure solve problems associated with using computer systems to perform model updates, the frequency and accuracy of which may greatly impact safe operation of robotic systems. These problems are unique to, and may have been created by, various computer-implemented methods for dealing with aspects of frequency and other aspects pertaining to model updates. Some embodiments are directed to approaches for carrying out a just-in-time model update protocol. The accompanying figures and discussions herein present example environments, systems, methods, and computer program products for performing situation-aware control system model updates.

### Overview

Modern robotic systems involve many “models”, which models are computer-readable representations of how the robot works (e.g., how an electrical signal corresponds to an applied torque) and/or how the robot interacts with its environment (e.g., how a pressure sensor responds to a touch, etc.). In legacy situations, such models have been implemented using handwritten computer-executable instructions such as, “If (current==2A) then torque=4 NM)” or “If (command==“ADVANCE5) then EXECUTE (motor_on, 10 Sec)”. Limitations of techniques involving human-written executable code have been met with the preference and adoption of data-centric models where robotic system behavior can be predicted based on interrelated values. For example, rather than modeling robotic system behavior using human-written executable code, instead, a table of values is populated with rows and columns or, more often, many tables of values are populated with many rows and columns. Continuing the former examples, a trivial robotic model might be codified as “TORQUE_TABLE (2, 4; 2.5, 5)” and “ADVANCE_TABLE (5, 10; 6,12; 8,16).”

The foregoing is a trivial example, presented merely to illustrate the fact that modern robotic systems involve many “models”, which models are computer-readable representations of how the robot works and/or how the robot interacts with its environment. Actual models in modern robotic systems involves many thousands of models, each with many thousands of rows and columns, and a corresponding multitude of table cell values. This has been a boon to robotic system makers since computer-readable tables are easier to develop and maintain as compared to handwritten computer-executable instructions. Accordingly, data-centric models have become ubiquitous in robotics.

In real-life scenarios involving real physical systems that change over time and/or involving deploying a robot into a particular changing environment, etc., it turns out that the models become outdated (e.g., inaccurate) and need to be adjusted periodically. Adjusting a model to accommodate changes involves iterating through the values of the model and updating them to comport with then-current values. Doing so demands a significant amount of computing power. In some cases, the foregoing demands are so significant that updating a model cannot be performed while the robot is operating to accomplish its mission.

Prior attempts to deal with the foregoing scenario in robotic systems have all failed. One class of prior attempts naively updates the model in accordance with a periodic schedule (e.g., in a synchronous, polling-style manner). For example, the model might be subjected to updates every one hour (or every one minute or every 30 seconds, etc.). This technique is deficient at least in that the periodicity might not match the need for the robot to operate on the basis of an updated model. For example, it could happen that some consequential condition (e.g., breaching a threshold) might occur just after a model update, thus leading to the unwanted situation where the model is inaccurate (or wildly wrong) for nearly the entirety of the periodic cycle until the next periodic model update event.

Another class of prior attempts naively updates the model by applying model updates in an event-driven manner (e.g., applying model updates asynchronously). For example, in this naive approach, the model update routine is invoked every time a change in the physical system and/or a change in the environment is detected. In practice, this often leads to an extremely high frequency of applying model updates. Even when an allowed range of deviation is considered, this naive approach still leads to the unwanted situation where computing demands to update the model skyrocket. In some cases, the computing demands needed to update and validate the model lead to overloading the available computing resources, possibly impacting the robot's ability to complete its mission. The naivety of the foregoing asynchronous approach is that, in real systems, there are far too many events in any given time slice, thus leading to resource overloading.

As can be seen from the foregoing, managing the model update schedule synchronously leads to non-optimal robotic system behavior. Similarly, but for different reasons, managing the model update schedule asynchronously also leads to non-optimal robotic system behavior.

Yet another class of prior attempts involves comparing a particular parameter of a model to a measured value for the particular parameter and then updating the model if it is determined that the particular parameter of the model deviates from the measured value (i.e. the model is at least potentially inaccurate). For example, a prior attempt might update a model when the measured value deviates more than 10% from the value predicted by or output by the corresponding model. This approach leads to non-optimal implementations that suffer from incurring the costs of model updates even when the model update and subsequent use of the updated model would not affect safe operation of the robot.

What is needed is a way to update the model only as frequently as is actually needed. It has been a long-felt need to answer how often the model of a robotic system should be updated. A rational answer would at least depend on factors such as the dynamics of the environment, the accuracy (i.e., changing accuracy) of the sensors, and importantly, the type and amount of computational resources available.

To address this need, certain of the disclosures herein provide techniques whereby model updates are scheduled only when model update is known to pertain to safe operation of the robot under then-current conditions.

It is natural—but possibly wrong—to say that the model should be updated frequently to ensure that the robot can perform its task safely and efficiently, and without compromising the quality of the output or the stability of the system. To explain, a robot that operates in a highly dynamic and uncertain environment, such as a rescue robot, may need to update its model more frequently than, for instance, a robot that performs a repetitive and predictable task under nearly unchanging or slowly-changing environmental conditions, such as would pertain to a welding robot. However, saying that the model should be updated “frequently” or “as often as possible” fails to explicitly take into account the need for accuracy (e.g., that may affect the degree of risk) with respect to the robot's mission.

Furthermore, saying that the model should be updated “frequently” or “as often as possible” fails to explicitly take into account the limitations of the hardware and software components of the system. That is, updating the model requires processing a stream of measurement data from the sensors to identify variations from historical measurements, calculating and applying needed changes and, finally, validating the resulting model for consistency and other characteristics. Such updates consume time, energy, and bandwidth, any one or more of which may be scarce or expensive, and/or which updates might introduce intolerable—or at least unwanted—latency in a cyber-physical system's operation.

One observation that derives from extensive development efforts and experience is that not all parameters of a model need to be accurate all of the time. Moreover, not all parameters of a model affect the robot's ability to carry out a particular mission. Still further, not all parameters of a model affect the robot's ability to carry out a particular operation within the contours of some stated acceptable risk (e.g., risk with respect to safety considerations). This leads to a conclusion that one way to strike a balance between resources demanded by the model update processes vis-a-vis the then-current accuracy of the models is to limit the number of parameters to be updated. This in turn leads to the intuition that only those changing model parameters that affect the then-current robotic operations need to be updated frequently. Since the amount of resources demanded by the model update processes is typically proportional to the number of parameters involved, it emerges that indeed, performing model updates using only those changing model parameters that affect the then-current robotic operations satisfies the need to operate within a risk contour while still only parsimoniously demanding computing resources.

One way to advance the known art in this space is to classify robotic model parameters (e.g., time-varying variables, constants, etc.). There are many ways to classify robotic model parameters. For example, robotic model signals might fall into one or more different criteria, such as (1) the type of parameter, (2) the source of the parameter value, (3) the representational domain of the parameter, (4) a specific property or combination of properties of the robotic model parameters, and (5) behavioral aspects affected by the parameter.

As examples of a “type” of a parameter might be classified as analog or digital, or continuous or discrete, or periodic or aperiodic, or finite or infinite, or deterministic or random, and so on. As examples pertaining to the “source” of a parameter, such parameters can be classified as (1) sensory signals, (2) actuator signals, (3) communication signals, and/or (4) control signals. As examples pertaining to the “representational domain” of the parameter, such parameters can be classified as (1) time-domain parameters, (2) frequency-domain parameters, or (3) spatial-domain parameters. As examples pertaining to the “property” or “properties” of the parameters, these can be classified as (1) causal or non-causal, (2) even or odd, (3) symmetric or asymmetric, or (4) stationary or non-stationary. As examples pertaining to “behavioral” aspects affected by the parameter, such a parameter may pertain to (1) speed of completion of a given operation or mission, (2) human likeness of a particular robotic movement, and/or (3) safe operation (e.g., within the bounds of a risk contour) while carrying out a given mission.

This last classification, referring to “behavioral” aspects affected by a given parameter leads us to an understanding that there are some parameters that are safety related and some that are not safety related.

As used herein, safety-related robotic model parameters are those values that are considered when instructing the robot to operate within a set of operational boundary conditions. Operational boundary conditions may refer to actual physical boundaries (e.g., a brick wall), or boundary conditions may refer to defined limits (e.g., maximum electrical currents, maximum torque, maximum velocities, minimum allowable distance from a surface, etc.). Certain types of limits can be codified as inequality expressions or other expressions that constitute a control barrier function (CBF). Control barrier functions, including possible implementation choices, are now briefly discussed.

### Control Barrier Functions (CBFs) and the Notion of Invariance

In the realm of robotics, a control barrier function (CBF) operates to ensure safety. As used herein the term “safety” refers to preventing undesirable events or “bad” things from happening during operation of the robot. The term “invariant” refers to maintaining certain properties over time. In common parlance, if a robotic system starts within a specific region, it might be constrained such that it would never leave that region. Control barrier functions (CBFs) can be used in robotic systems to define a region.

In the context of the present disclosure, and to further explain how various ones of the techniques disclosed herein are distinguished from certain of the prior attempts, Table 1 presents update styles for comparison.

TABLE 1
Example model update styles

| Model Parameter | Model CBF Output |
|---|---|
| Deviation Style | Deviation Style |
| Update a model when the value | Update a model when the value |
| Model (P1_measured) deviates more | CBF (P1_measured) deviates more |
| than a predetermined amount from | than a predetermined amount from |
| Model (P1_model); | CBF (P1_model); |
| where P1 is a parameter that is | where P1 is a parameter that is |
| both empirically measurable as | both empirically measurable as |
| well as used in model model. | well as used in the CBF of model |
| | model. |

As used herein, the terms “control barrier function” or “control barrier functions” are used interchangeably with the terms “control invariant barrier function” or “control invariant barrier functions”, respectively. As used herein, CBFs are mathematical functions that define a positive invariant set within a safety region. Given effectivity of an appropriately-specified CBF in a robotic control system, then when the robot approaches the boundary of the specified region, the control input ensures that the robot remains within the interior of the region. In this sense, CBFs act as safety constraints that operate in concert so as to prevent the robot from entering what are potentially unsafe regions. Use of CBFs is prevalent in safety-critical controllers of robotic systems. They are used to enforce boundary conditions (e.g., safety properties or conditions) that would apply in scenarios where a robot is deployed to operate in an unknown or uncharacterized environment.

As used in some embodiments discussed herein, a “control barrier function” characterizes or calculates a relationship between a CBF input and a corresponding CBF output, wherein the relationship includes at least one constraint (e.g., “velocity must be maintained at less than X feet per second”). Constraints may be codified using one or more inequalities, and inequalities in turn may be expressed as a mathematical model (e.g., a computer-evaluable expression), or as a table, or as a lookup function, or using any known technique that can be used to relate one or more robotic model parameters to one or more operational boundary conditions. Operational boundary conditions may refer to actual physical boundaries (e.g., a brick wall), or operational boundary conditions may refer to defined limits (e.g., maximum electrical currents, maximum torque, maximum velocities, minimum allowable distance from a surface, etc.). Operational boundary conditions can be codified as inequalities that constitute a control barrier function (CBF).

Operational boundary conditions can be codified in a manner that relates robotic behavior to aspects of the environment. Still further, such operational boundary conditions may relate to cyber-physical capabilities of the robot. For example, an operational boundary condition such as, “keep acceleration below 5 meters/second²” would depend on sufficient accuracy in the cyber-physical model of the actuators (e.g., motors, brakes, steering) such that the robot can be accelerated, steered, and decelerated (e.g., subjected to braking actions) with sufficient precision so as to actually control the robot to observe the operational boundary condition of “keep acceleration below 5 meters/second².”

In many settings, there are also environmental boundary conditions. For example, an environmental boundary condition might pertain to the semantic of “do not cross the double yellow line,” and/or (using a more positive connotation language) “stay at least 15 inches away from the double yellow line.” Still further, there are mission-specific boundary conditions such as, “complete the assigned task within 3 seconds from start to finish.” In some cases, a boundary condition of one type can be implemented by codifying one or more boundary conditions of another type. Some examples are shown and described as pertains to Table 2.

TABLE 2
Example boundary condition implementations

| Semantic | Implementation |
|---|---|
| Mission-specific Boundary | Operational Boundary Condition: |
| Condition: | Carry out a series of instructions |
| Accomplish the mission as quickly | wherein performance of a given |
| as possible, but do not compromise | instruction does not violate any |
| safety | operational limits |
| Environmental Boundary Condition: | Operational Boundary Condition: |
| Avoid bumping into the wall | Keep acceleration below 5 m/s\hat{ }2 |
| | Operational Boundary Condition: |
| | Stay within the robot's |
| | maneuverability limits |
| Environmental Boundary Condition: | Operational Boundary Condition: |
| Fly level to the terrain | Limit pitch to a maximum of 3 |
| | degrees |

The foregoing are merely examples. Any types or forms or number of boundary conditions can be combined and/or concurrently applied such that safety is ensured.

Those of ordinary skill in the art will recognize that robotic systems may include literally thousands of models, the fidelity of which models may (or may not) play a role in operational safety of the system. For example, a robotic model that relates an input signal (e.g., an ‘accelerate’ command) to a power control of a robotic actuator probably plays a role in the operational safety of the robotic system, at least inasmuch as the model should avoid making sudden changes that are so fast that such a sudden change may challenge the operational reaction time of another nearby robot. On the other hand, a model that correlates accomplishment of a mission or task to a checklist (e.g., to merely click off the checkbox) probably does not play a role in the operational safety of the robotic system. To explain further, robotic systems often have robotic models that operate across a vast range of impact levels. Again, a robotic model that relates an input signal (e.g., an ‘accelerate’ command) to a power control of a robotic actuator probably plays a role in operational safety of the robotic system, whereas a robotic model that relates a visual input signal (e.g., the color or hue of a pixel) to a color correction module probably does not play a role in operational safety of the robotic system.

Now, with the foregoing dramatic example as a backdrop, one can recognize that even though a robot's models need to be accurate across a wide range of operational parameters (e.g., coefficients of friction, ambient temperatures, etc.) and over a defined time span, or possibly for the entire duration of the service life of the robot, it is naive to revisit the accuracy of all models when conditions change (e.g., when the coefficients of friction at the drive wheels change, when ambient temperatures change, when a robotic component has exceeded it rated service life, etc.). This is because updating a model involves use of non-zero amounts of computing resources (e.g., MIPS, memory), and moreover, updating a model introduces a non-zero amount of delay time during which delay time the model is either wrong or temporarily unavailable for use in performing modeling calculations.

Some approaches for parsimoniously updating models relies on a priori knowledge of the role of the model and its threshold of sensitivity with respect to safety considerations. Some approaches regularly (e.g., on a fixed periodic schedule) update all such models that breach a threshold of sensitivity. Some approaches update certain models based upon external events (e.g., a software or firmware upgrade). However, the foregoing approaches all exhibit serious unwanted side effects which are strongly eschewed as they can lead to unintended and sometimes unsafe behaviors of the robot. Table 3 presents various model update approaches, deficiencies that emerge with respect to use of those model update approaches, and ways to address these deficiencies.

TABLE 3
Remediations

| Approach | Example Deficiencies | Example Remediations |
|---|---|---|
| Initiate model updates | Wastes an enormous amount of | Only update the model when needed |
| very frequently | computing resources | (e.g., just in time, based on then- |
| | | current events) |
| Initiate model updates | The model can become inaccurate, | Cause the model to be updated when |
| very infrequently | potentially disastrously inaccurate | needed (e.g., just in time, based on |
| | | then-current events) |
| Update all parameters | Wastes an enormous amount of | Only update certain parameters of the |
| of a given model | computing resources since some | model, and only when needed (e.g., |
| | parameters are not relevant to the | just in time, based on then-current |
| | then current scenario | events) |
| Update only an a priori | If the a priori defined set of | Only update certain parameters of the |
| defined set of | parameters is incorrect or outdated, | model, and only when needed (e.g., |
| parameters of a given | the model can become inaccurate, | just in time, based on then-current |
| model | potentially disastrously inaccurate | events) |
| Update all parameters | Wastes an enormous amount of | Recode the model to include control |
| of a given model | computing resources since some | barrier functions, then only update |
| | parameters are not relevant to the | parameters of the control barrier |
| | then current scenario | functions portion of the model, and |
| | | only when needed (e.g., just in time, |
| | | based on then-current events) |
| Regularly update | The control barrier function itself | Dynamically regenerate a model's |
| parameters of the | may become out of date or | control barrier functions whenever |
| control barrier functions | irrelevant to conditions in a | needed (e.g., just in time, based on |
| of a given model | changing environment | then-current events) |

As can be seen there is a remediation suggested for every one of the listed approaches. Furthermore, many of the remediations involve intelligently choosing what models to consider for updating as well as what model parameters to consider for updating. The foregoing examples also indicate a just-in-time approach whereby the considered models are updated as infrequently as possible, but nevertheless in sufficient time to avoid a potential impact to safety. In some cases, possibly beyond the few examples given in Table 3, the application of a model update might involve updating only a portion (e.g., some particular model value or model values, or some particular input signal or combination of signals, etc.)

Disclosed herein in the written description supra and in the corresponding figures are various approaches to for performing situation-aware control system model updates.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

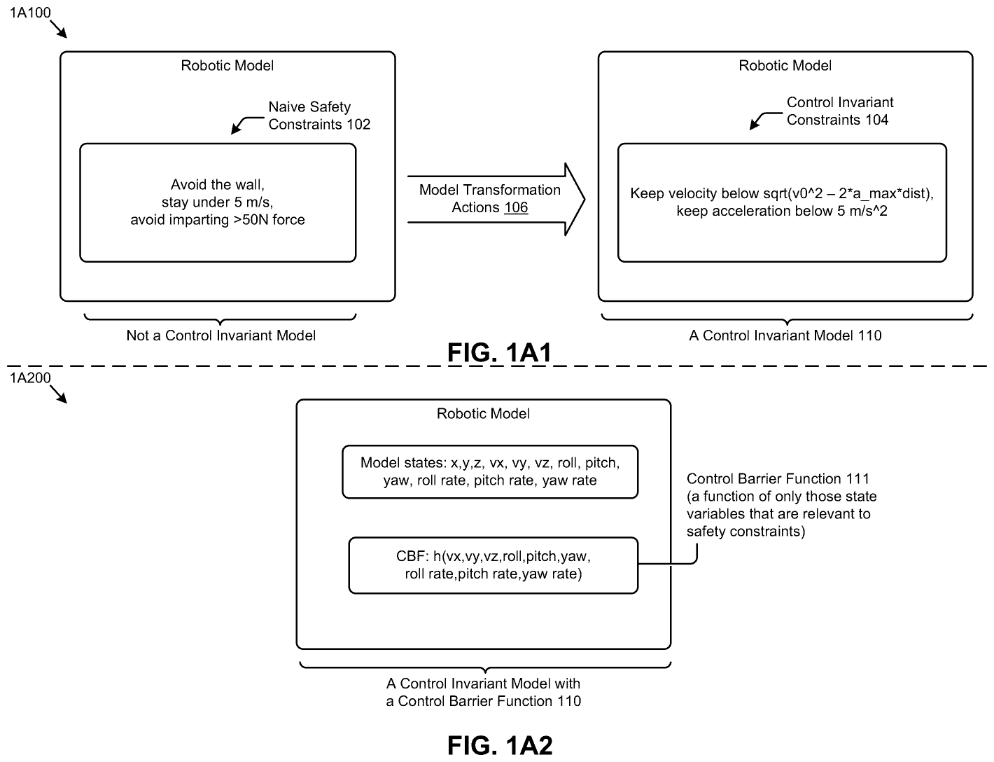

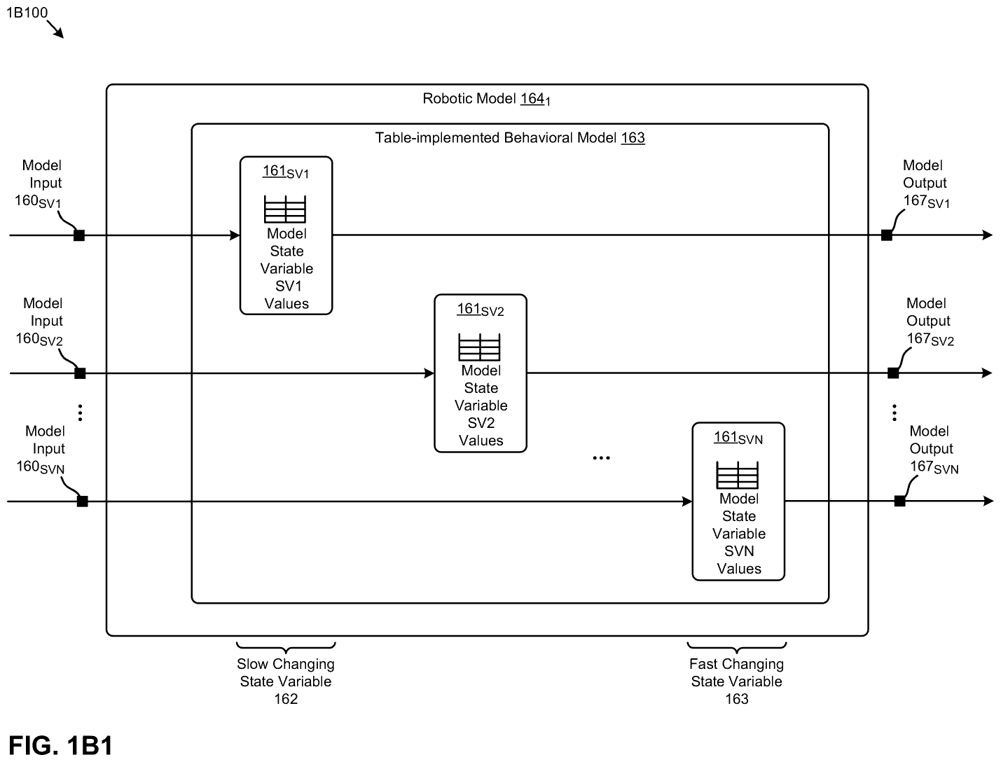

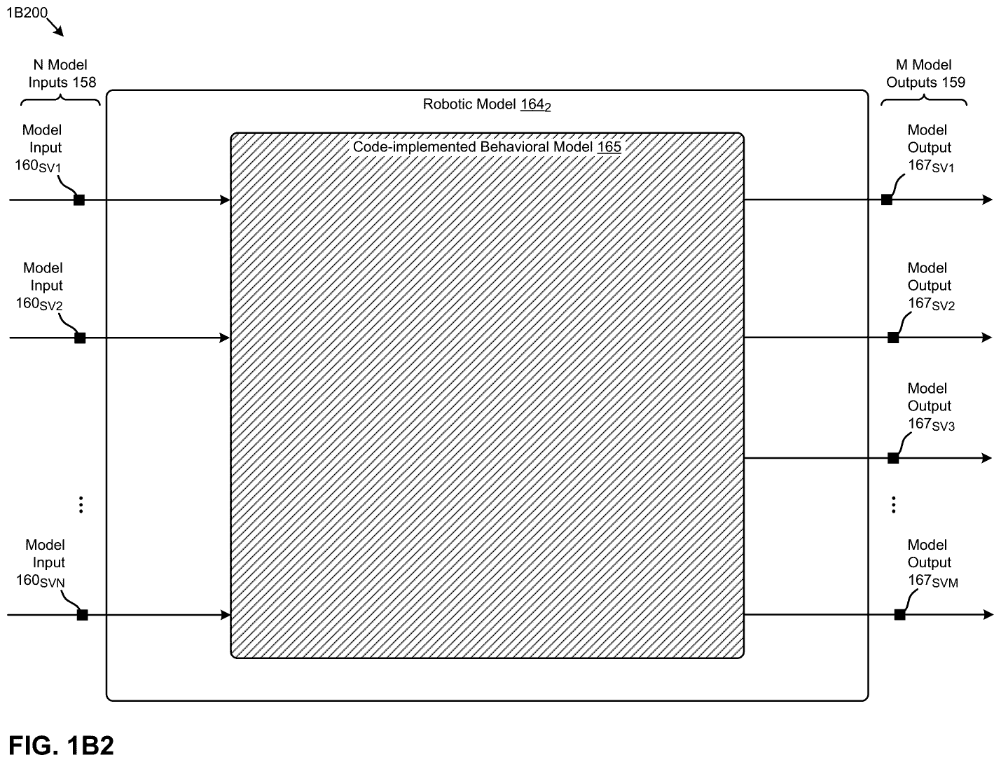

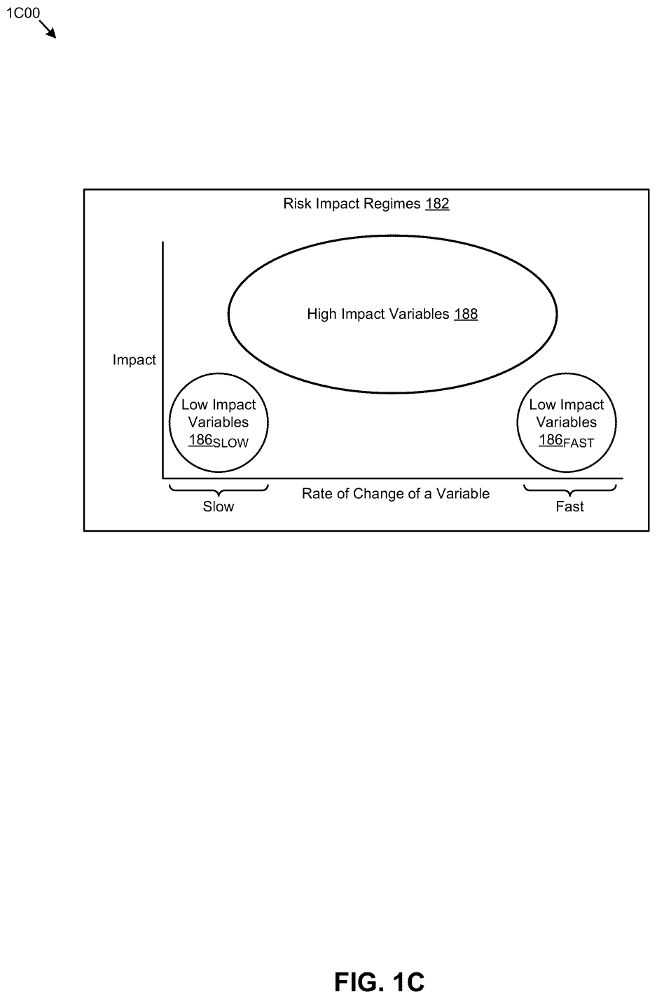

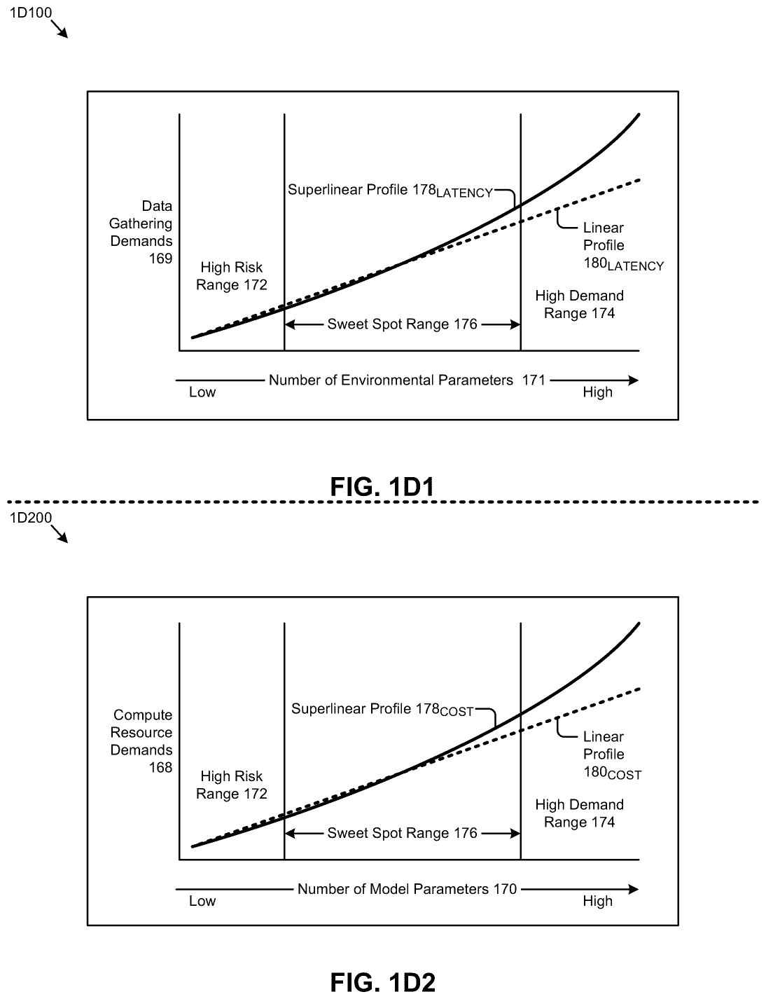

FIG. 1A1 depicts a model transformation technique as used in systems that perform situation-aware control system model updates. As an option, one or more variations of model transformation technique 1A100 or any aspect of the shown model transformation actions 106, or any aspect of the foregoing may be implemented in the context of the architecture and functionality of the embodiments described herein and/or in any environment.

The figure is being presented to illustrate an example of how a set of model transformation actions 106 might be undertaken such that vague model semantic representations of constraints (e.g., naive safety constraints 102 such as “avoid the wall”) can be transformed into situation-aware constraints. Given a model that has computer-executable codifications of situation-aware constraints (e.g., the shown control invariant constraints 104), then robotic safety guardrails (e.g., control models, control barrier functions, etc.) can be established. Moreover, such safety guardrails can be expressed as limits that have the desired function of preventing the robotic system from operating outside of some safety envelope.

Continuing, following this particular technique for this particular illustrative example, then the safety sensitivity of aspects of the limits can be considered, and only those parameters or models that have a sufficiently high safety sensitivity need be considered for model updates. One of skill in the art recognizes that the determination as to whether or not the foregoing parameters or functions have a sufficiently high safety sensitivity can be done dynamically—even while the robotic system is in the process of accomplishing some mission. In fact, dynamic determination as to whether or not a particular then-current parameter value or then-current codification of a control function has a sufficiently high safety sensitivity can be based on dynamically determined values such as a threshold value. Additionally or alternatively, a determination as to whether or not a particular then-current parameter value or then-current codification or output of a control function has a sufficiently high safety sensitivity can be based on one or more pre-determined values such as a pre-determined threshold value. As used herein, the term predetermined refers to the situation where an aspect is codified prior to a later timeframe when the same aspect is calculated dynamically or otherwise dynamically determined. Strictly as one example, some embodiments disclosed herein avail of a pre-determined threshold value, whereas other embodiments calculate and avail of dynamically determined threshold values. As another example, some embodiments disclosed herein avail of a pre-determined model variable (or pre-determined model variable value), whereas other embodiments calculate and avail of one or more dynamically determined model variables (or dynamically determined model variable values).

In this example, the shown model transformation actions 106 result in transformation from a naive model into a control invariant model 110, which control invariant model includes any number of control invariant constraints.

In some embodiments, transformation 106 implements a control methodology that unifies control barrier functions (CBFs) and control Lyapunov functions. The methodology addresses all of (1) safety considerations, (2) performance considerations, as well as (3) real-time system component behaviors (e.g., actuator dynamism, sensor inaccuracies, etc.). As used advantageously in the herein-described environments, a CBF can be dynamically constructed in the context of real-world situations and conditions. As such, existence of such a dynamically constructed control barrier function satisfies both (1) the need for a guarantee of safe operation in the aforementioned real-world situation and (2) operation of the robot under conditions that imply forward invariance. In some embodiments, such dynamically constructed CBFs are unified with control Lyapunov functions (CLFs). This facilitates simultaneous achievement of control objectives (represented by CLFs) subject to conditions on the admissible states of the system (represented by CBFs).

The foregoing discussion of FIG. 1A1 pertains to merely some possible embodiments and/or ways to implement a model transformation technique. Many variations are possible, for example, the model transformation technique as comprehended in the foregoing can be implemented in any environment and using any transformation technique, one possible example of which is shown and described as pertains to FIG. 1A2.

FIG. 1A2 depicts a control invariant model having a control barrier function. As an option, one or more variations of control invariant model 1A200 or any aspect thereof may be implemented in the context of the architecture and functionality of the embodiments described herein and/or in any environment.

The foregoing discussion of FIG. 1A1 introduces the concept of a control barrier function. FIG. 1A2 presents an illustrative example of how a control barrier function 111 operates in systems that perform situation-aware control system model updates. This figure presents an example control barrier function that is defined in terms of only those state variables that are relevant to safety constraints.

To explain more fully, consider a robotic model that is used in portions of a control system of an autonomous drone. As pertains to the motion of flight for an airborne vehicle, a model might have a state variable for X position (shown as state variable ‘x’), a state variable for Y position (shown as state variable ‘y’), a state variable for Z position (shown as state variable ‘z’), a state variable for velocity in the X direction (shown as state variable ‘vx’), a state variable for velocity in the Y direction (shown as state variable ‘vy’), a state variable for velocity in the Z direction (shown as state variable ‘vz’), a state variable for ‘roll’, a state variable for ‘pitch’, a state variable for ‘yaw’, a state variable for ‘roll rate’, a state variable for ‘pitch rate’, and a state variable for ‘yaw rate’. It should be noted that, while the foregoing parameters are important for observing and controlling aspects of the motion of flight for an airborne vehicle, those of skill in the art can observe that, for example, the X distance between the airborne vehicle and an obstacle is nearly irrelevant for managing safety.

Stated differently, the entire range of X distances from one angstrom of distance from the obstacle to much larger distances from the obstacle are safe (i.e., no collision if there is a non-zero distance). Thus, the X distance from to an obstacle is nearly irrelevant with respect to collision avoidance. As is said, “a miss is a good as a mile.” In contrast, if at some point in time the X direction velocity (e.g., velocity toward the obstacle) is over some threshold, then it might be impossible for the airborne vehicle to take evasive maneuvers. This is because, if the collision course is detected at a late moment in time, there may be no way for the airborne vehicle to overcome the forces of nature. For at least reasons of safety, this situation is to be avoided, and can be avoided indeed by dealing with the X direction velocity.

Now, relating the foregoing scenario, the know-how of how to choose which models to consider for updating as well as the know-how of when to apply an update is disclosed. In discussing the know-how of how to carry out model updates, it can be seen that there is an intelligence involved in making such choices as to which models to consider for updating. Furthermore, it can be seen that there is an intelligence involved in determining when to update what portions of said models. Many of the techniques to apply intelligence dynamically involve an understanding or determination of how the model is implemented. For example, if a model is implemented as a mathematical expression of several parameters, then there is some intelligence needed to determine which of the several parameters are pertinent to the then-current environment and/or safety considerations. In a different example, if a model is implemented as a series of input-output pairs of parameters (e.g., a multi-column table of parameters that relates a given input parameter value to one or more output parameter values), then there is some intelligence needed to determine which of the several parameters are pertinent to the then-current environment and/or safety considerations.

What follows are examples of, respectively, a model implemented as a series of input-output pairs involving particular parameters codified in tables (FIG. 1B1) and a code-implemented model involving particular parameters (FIG. 1B2).

FIG. 1B1 depicts a table-implemented behavioral model as used in systems that perform situation-aware control system model updates. As an option, one or more variations of table-implemented behavioral model 1B100 or any aspect thereof may be implemented in the context of the architecture and functionality of the embodiments described herein and/or in any environment.

The figure is being presented to illustrate how a table-implemented behavioral model 163 might be configured to operate in any given environment. Considering afresh the foregoing discussion regarding updating parameters that are pertinent to the then-current environment and/or safety considerations. It follows that there is a need for developing a knowledge of, or a technique for determining, which of a set of table parameters are pertinent to the then-current environment and/or safety considerations.

The shown robotic model 1641 includes a plurality of table-implemented behavioral models having model respective inputs (e.g., model input 160_{SV1}, model input 160_{SV2}, . . . , model input 160_{SVN}) each of which, in turn, have respective outputs (e.g., model output 167_{SV1}, model output 167_{SV2}, . . . , model output 167_{SVN}), which outputs are produced by respective sets of state variable models (e.g., state variable model 161_{SV1}, state variable model 161_{SV2}, . . . , state variable model 161_{SVN}). For purposes of illustration, state variable model 161_{SV1} is associated with slow changing state variable model 162, whereas state variable model 161_{SVN} is associated with fast changing state variable model 163.

To explain further, with respect to the specifics of the shown table-implemented behavioral model, consider the situation where certain components of actuators undergo wear over time. And further consider that such wear would affect the accuracy that the actuator can perform to a command (e.g., as there is more and more wear, there will be less and less accuracy). Now, consider the underpinnings of a calibration system whereby measurements are taken (e.g., measurements pertaining to wear of yaw actuator components), and on the basis of such measurements, a yaw actuator model can be recalibrated. Even though, in this example, the yaw component that is undergoing wear cannot be replaced while in use (e.g., while the robot is on a mission), it is possible to update the model so as to maintain accuracy in yaw control as might be needed for performing evasive maneuvers and/or for coherence to the physics of flight dynamics. To wit, consider where a table-implemented model for the yaw actuator is in the form of rows of triplets, each row formed of {‘input parameter value’, {‘output parameter value’, ‘measured accuracy variance’}} (e.g., {'1′, {'25′, ‘+/−2’}}). In a recalibration scenario, many (possibly all) of the values of the ‘measured accuracy variance’ across all rows might change to reflect the uncertainty (e.g., the foregoing ‘+/−2’ might become ‘+/−3’).

One of skill in the art will recognize that certainty as to minimums and maximums of the yaw might be critical when the airborne vehicle is executing an evasive maneuver.

The foregoing is an illustrative example of a slow changing state variable-changing very slowly under conditions of ongoing wear and tear. However, consider a (potentially) fast changing state variable 163 such as an altitude predictor. What is needed here is at least a recognition that one or more state variables pertaining to altitude might change very quickly based on flight dynamics. That is, if the autonomous drone is in the midst of executing a dive maneuver the predictor might need to be updated frequently, and at least inasmuch as the drone might be in freefall (e.g., the altitude is quickly changing at a rate of 32 feet/second²) and/or inasmuch as the drone might be in the midst of a dive maneuver (e.g., the altitude is changing at a rate much faster than 32 feet/second²). Therefore, what is needed is to be aware that such a predictive model or portions thereof might be changing rapidly, and further, to be aware that a model that outputs such a state variable prediction pertaining to altitude might need to be updated quite frequently in order to be accurate enough to guarantee an acceptable degree of risk.

The foregoing discussion of FIG. 1B1 pertains to merely some possible embodiments and/or ways to implement a table-implemented behavioral model. Many variations are possible, for example, the table-implemented behavioral model as comprehended in the foregoing can be implemented in any environment, many examples of which are shown and described herein. One of skill in the art will recognize that a table-implemented behavioral model is merely one way to implement a behavioral model. Many other modeling techniques exist, one example of which is shown and described as pertains to FIG. 1B2.

FIG. 1B2 depicts a code-implemented behavioral model instance as used in systems that perform situation-aware control system model updates. As an option, one or more variations of code-implemented behavioral model instance 1B200 or any aspect thereof may be implemented in the context of the architecture and functionality of the embodiments described herein and/or in any environment.

The figure is being presented to explain what a code-implemented behavioral model is, and to illustrate how a code-implemented behavioral model might be updated in accordance with some specific series of events and/or based on the then-current conditions.

Now, as used for the illustrative example of FIG. 1B2, a code-implemented behavioral model 165 is a data transformer that involves one or more “IF-THEN-ELSE” statements. More specifically, a code-implemented behavioral model takes in one or more input values and outputs one or more output values. Strictly as an example, a code-implemented behavioral model might include an “IF-THEN-ELSE” statements in the form, “IF(low_range_value<input_value && input_value<high_range_value) THEN return(input_value) ELSE return (−1);”. The expressions in the “IF-THEN-ELSE” statements can be arbitrarily complex. In many cases, the expressions in such “IF-THEN-ELSE” statements involve multiple input values. In many cases, the expressions in such “IF-THEN-ELSE” statements involve multiple output values. There need not be any particular one-to-one correspondence between input values and output values, although there might be such a correspondence. There need not be any particular many-to-one correspondences between input values and output values, although there might be such correspondences. There need not be any particular one-to-many correspondences between input values and output values, although there might be such correspondences.

FIG. 1B2 shows a generalized code-implemented instance of a robotic model 164₂ that includes N model inputs 158, where, in this example, N=3 (shown as model input 160_{SV1}, model input 160_{SV2}, and model input 160_{SVN}) and M model outputs 159 where M=4 (shown as model output 167_{SV1}, model output 167_{SV2}, model output 167_{SV3}, and model output 167_{SVM}).

The foregoing discussion of FIG. 1B2 pertains merely to some possible embodiments and/or ways to implement a code-implemented behavioral model 165. Many variations are possible, for example, the code-implemented behavioral model as comprehended in the foregoing can characterize the behavior or predicted behavior of any of a wide range of values (e.g., variables or constants) and/or may be implemented in any environment. In some cases, a robotic model—whether implemented as one or more table-implemented behavioral models, or whether implemented as one or more code-implemented behavioral models, or whether implemented using some other technique—can be used in conjunction with a risk assessment.

FIG. 1C is a risk impact chart showing multiple risk impact regimes that correspond to just-in-time digital control system model update scheduling techniques. As an option, one or more variations of risk impact chart 1C00 or any aspect thereof may be implemented in the context of the architecture and functionality of the embodiments described herein and/or in any environment.

The figure is being presented to illustrate how a risk impact assessment (e.g., via a risk impact chart or a risk impact function, etc.) might be configured to operate in a deployment that considers multiple risk impact regimes 182. The particular risk impact regimes presented here are merely for purposes of illustration and other risk impact regimes are possible. In the particular example embodiment of FIG. 1C, an impact variable (shown as the ordinate of the chart) is a function of a rate of change of a particular variable. As can be seen, impact (e.g., risk impact) is not necessarily a linear function of the rate of change of a variable. Nor is impact even a monotonically increasing function of the rate of change of a particular variable. More particularly, one or more variables can be classified or deemed to be a low impact to risk, or a variable can be classified or deemed as a high impact to risk. This is depicted by the existence of various areas of the chart. As shown, a first area of the chart (labeled as low impact variables 186_{SLOW}) is distinguished by covering a different area of the chart than the area covered by high impact variables 188. Similarly, and again as shown, there is a second area of the same chart (labeled as low impact variables 186_{FAST}) which again is distinguished by covering a different area of the chart than the area covered by high impact variables 188.

Now, referring to the area of the chart labeled as high impact variables 188, certain high impact variables can be classified as such regardless of their correlation to a slow rate of change of a variable or regardless of their correlation to a fast rate of change of a variable. A classifier, such as referred to in the foregoing, can be implemented using any known technique, including via a machine learning model that is trained over one or more corpora of learned data. In some cases, a machine learning model can be trained over one or more corpora of data derived from application of reinforcement learning techniques.

As can now be understood, one aspect of the advance disclosed herein is the awareness of when to re-evaluate a model (e.g., to comport the model with some acceptable degree of precision and accuracy). As a corollary, another aspect of the advance disclosed herein is the awareness of when not to re-evaluate a model. Having the foregoing awareness that is informed, at least in part, on a risk impact assessment means that models can be updated and/or re-evaluated and/or recalibrated parsimoniously, thus avoiding wasting computing resources on model updates.

The foregoing discussion of FIG. 1C pertains to merely some possible embodiments and/or ways to implement a risk impact chart. Many variations are possible, for example, the risk impact chart as comprehended in the foregoing can be used in conjunction with resource demand predictors, examples of which are shown and described as pertains to FIG. 1D1 and FIG. 1D2. More specifically, the risk impact chart as comprehended in the foregoing can be used in conjunction with an assessment of how much (and what type of) data/parameters (e.g., environmental data/parameters) need to be gathered as well as an assessment of how much (and what type of) computing resources need to be expended in order to update a model.

FIG. 1D1 is an environmental data gathering demand predictor as used when implementing control invariant models. As an option, one or more variations of environmental data gathering demand predictor 1D100 or any aspect thereof may be implemented in the context of the architecture and functionality of the embodiments described herein and/or in any environment.

The figure is being presented to illustrate that data gathering demands 169 are a function of the number of environmental parameters 171. Further, the figure is being presented to illustrate a “sweet spot” (i.e., sweet spot range 176) that lies somewhere in the middle between a low number of environmental parameters (e.g., where there is very little information available about the environment) and a high number of environmental parameters. In the latter case where there are a large number of environmental parameters that need to be considered, the data gathering demands might be high (e.g., as shown by the dotted line forming linear profile 180_{LATENCY}) in the high demand range 174) or possibly even much higher (e.g., as shown by the solid line forming superlinear profile 178_{LATENCY}). In the former case, if there are very few environmental parameters that are available to be considered, the data gathering demands might be low, but there is inherent risk involved in operating a robot in an environment that has very little knowable information about it. This is shown in the chart as a high risk range 172.

As contemplated, a chart such as is depicted in FIG. 1D1 can be used to predict the amount of resources demanded to do the needed data gathering for the purpose of updating a robotic model. Those of skill in the art will recognize that ongoing operation of a robot might involve a so-called explore/exploit scenario where there is a limited amount of time to do data gathering, and where, based on adherence to such a time limit, fewer than all environmental parameters are considered for data gathering in favor of using a limited amount of time to exploit the use of environmental data that had been collected within the time limit.

The foregoing discussion of FIG. 1D1 pertains to merely some possible embodiments and/or ways to implement an environmental data gathering demand predictor. Many variations are possible, including using the demand predictor in changing environments. Moreover, in addition to the need to manage resources (including time) demanded for data gathering for cyber-physical safety systems such as are contemplated herein, there is also the need for computing/processing the data that had been collected. Accordingly, and especially in an explore/exploit scenario, there is a need for predicting the amount of computing resources that would be required to exploit the meaning of data that had already been collected. One possible implementation of a resource demand predictor is shown and described as pertains to FIG. 1D2.

FIG. 1D2 is a compute resource demand predictor, as used when implementing control invariant models. As an option, one or more variations of compute resource demand predictor 1D200 or any aspect thereof may be implemented in the context of the architecture and functionality of the embodiments described herein and/or in any environment.

The figure is being presented to illustrate that compute resource demands 168 are a function of the number of model parameters 170. Further, the figure is being presented to illustrate a “sweet spot” that lies somewhere in the middle between a low number of model parameters and a high number of model parameters. In the latter case where there are a large number of model parameters that need to be considered, the compute demands might be high (e.g., as shown by the linear profile 180_{COST} dotted line in the high demand range 174) or possibly even much higher (e.g., as shown by the superlinear profile 178_{COST} solid line).

As contemplated for many of the embodiments disclosed herein, a chart such as is depicted in FIG. 1D2 can be used to predict the amount of resources demanded to do the needed computing for the purpose of updating a robotic model.

The foregoing discussion of FIG. 1D2 pertains to merely some possible embodiments and/or ways to implement a compute resource demand predictor. Many variations are possible, including using the compute resource demand predictor in changing environments. Moreover, in addition to the need to manage resources (including time) demanded for computing for operation of the cyber-physical safety systems such as are contemplated herein, there is also the need for using only a threshold amount of computing resources to update a particular model at a particular time.

The foregoing compute resource demand predictor 1D200 or variation therefrom as well as the foregoing environmental data gathering demand predictor 1D100 or variation therefrom can be used to implement a just-in-time digital control system model update scheduling regime, wherein only certain first aspects (e.g., high priority aspects) of a model are scheduled to be subjected to model updates at a particular given point in time, and wherein other certain other aspects (e.g., aspects being deemed as low priority) of a model are scheduled to be subjected to model updates at a later point in time.

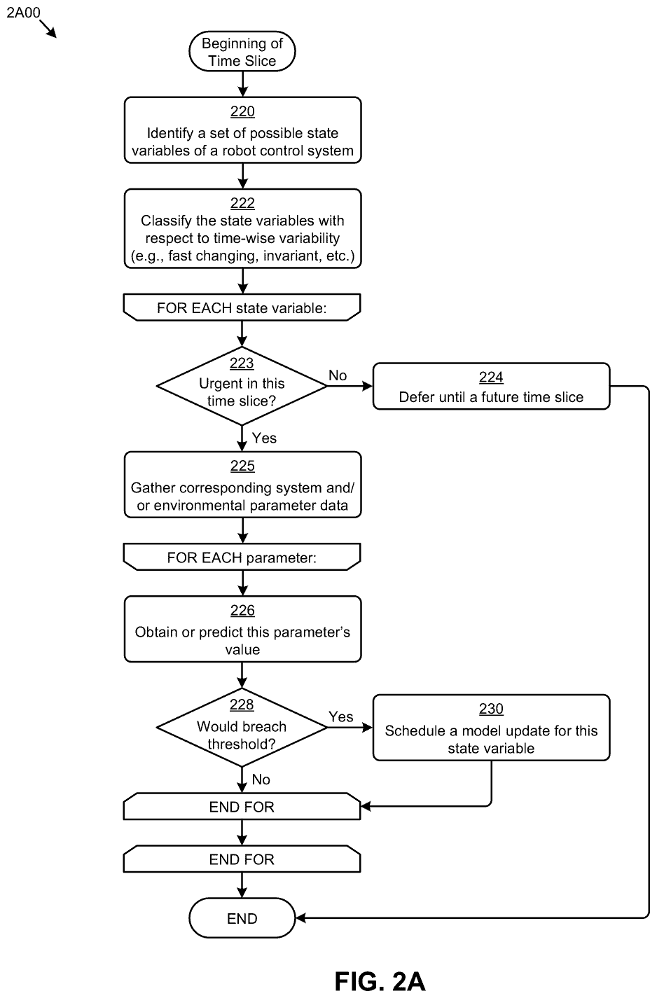

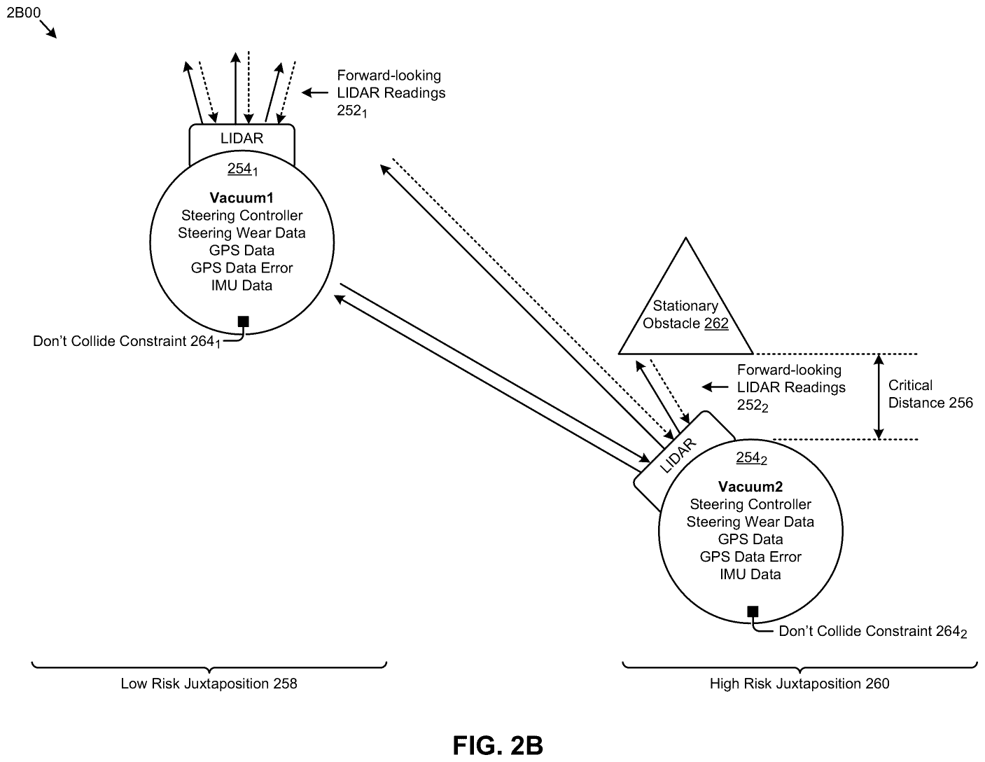

One example of a just-in-time digital control system model update scheduling technique is shown and described as pertains to FIG. 2A.

FIG. 2A is a flowchart depicting a just-in-time digital control system model update scheduling technique. As an option, one or more variations of flowchart 2A00 or any aspect thereof may be implemented in the context of the architecture and functionality of the embodiments described herein and/or in any environment.

The figure is being presented to illustrate how one or more aspects of a model (e.g., a set of one or more of the model's state variables) can be independently considered when determining (1) when to schedule gathering of environmental data, and (2) when to schedule use of computing resources to update those one or more aspects of a particular model.

As shown, flowchart 2A00 is entered at the beginning of a time slice. A time slice can begin upon the expiration of a timeout, or a time slice can begin upon some event occurrence in a particular cyber-physical system or its environment. Processing commences at step 220 where a set of possible state variables of a particular model are identified. Once the state variables are identified, then processing advances to step 222 where at least some of the identified state variables are classified with respect to a corresponding time-wise variability. This is because fewer than all state variables need to be considered in every time slice. In fact, there are many situations where only one or just a few state variables are candidates for further processing in a model update time slice. This is shown at decision 223 where a test is carried out to determine if a particular state variable (e.g., the particular state variable being the subject of the then-current FOR EACH loop) would breach some threshold of urgency. If not, then this particular state variable is deferred (at step 224) until a future time slice.

On the other hand, if the test carried out to determine if a particular state variable would breach some threshold determines that it is urgent (or at least quantitatively reasoned to be considered in the then-current time slice) then processing advances to step 225 that serves to gather corresponding system and/or environmental parameter data. Some (but often not all) of such environmental parameter data is needed for scheduling a model update for a particular model state variable. As such, each gathered parameter can be individually considered as to whether or not there is sufficient time (e.g., in an explore/exploit regime) and/or justification (e.g., with respect to the rate at which this parameter value changes) to obtain values for the considered parameter.

In the event that there is sufficient time and/or justification, then at step 226, the then current value or values of the subject parameter are obtained and preprocessed (e.g., normalized as needed) for a determination as to whether or not the obtained parameter value breaches a threshold (see the ‘Yes’ branch of decision 228). If so, then at step 230, at least a partial update of the model (e.g., an update of the portion of the model that corresponds to this parameter) is performed. Otherwise, if it is determined that the obtained parameter value not breach a threshold (see the ‘No’ branch of decision 228), then processing advances to the next parameter.

In some cases, there is a requirement to process model parameters in a particular order. This can happen, for example, if there is a specified or inherent logical hierarchy to the parameters. To more fully understand this, consider a state variable that is a function of other state variables (e.g., SC1=f(SVA and SVB)). In such cases, the inner values are considered before the outer value(s).

The foregoing discussion of FIG. 2A pertains to merely some possible embodiments and/or ways to schedule model updates. Many variations are possible, and deployment into any environment is also possible. Moreover, even in a particular given environment, there may be many different scenarios where and when a particular set of model state variables and/or a particular set of environmental parameters are used to determine when a particular portion of a model is to be urgently (e.g., just-in-time) scheduled for an update. Strictly for illustration, an operating environment depicting a scenario where a particular portion of a model is to be urgently updated is presented as pertains to FIG. 2B.

FIG. 2B exemplifies an operating environment depicting a scenario where just-in-time digital control system model update scheduling technique can be advantageously applied. As an option, one or more variations of operating environment 2B00 or any aspect thereof may be implemented in the context of the architecture and functionality of the embodiments described herein and/or in any environment.

The figure is a top-down view of two autonomous vehicles (shown as autonomous vehicle 254₁ and autonomous vehicle 254₂) which, in this case, are two room vacuums (e.g., vacuum1 and vacuum2). Each autonomous vehicle is equipped with its own LIDAR unit, and each with its own instance of a “don't collide” constraint (e.g., don't collide constraint 264₁ and don't collide constraint 264₂).

Now, consider that the two autonomous vehicles are in operation at the same time, and that the two autonomous vehicles are moving in the directed indicated by the shown forward-looking LIDAR readings (e.g., forward-looking LIDAR readings 252₁ and forward-looking LIDAR readings 252₂). Further consider that the first autonomous vehicle, shown as autonomous vehicle 254₁ is operating in a low risk juxtaposition 258 at the same time that the second autonomous vehicle, (shown as autonomous vehicle 254₂) is in a high risk juxtaposition 260. What is needed here for safe operation is for the second autonomous vehicle to avoid colliding with stationary obstacle 262. In other words, what is needed here for safe operation is for the second autonomous vehicle to manage its velocity (speed and direction) so as to avoid colliding with stationary obstacle 262. This is entirely possible given the instrumentation available (e.g., GPS data, GPS data error, IMU data, etc.) and given the vehicular controls available (e.g., steering controls, steering wear data, etc.). To explain, and to illustrate decision-making for determining any just-in-time model updates, consider the characterizations of the specific instrumentation and vehicular control facilities as shown in Table 4.

TABLE 4
Characterization of instrumentation and vehicular control facilities

| Facility | Characterization |
|---|---|
| GPS Data | Typically civilian-use GPS data has a resolution |
| | down to a meter or a few meters |
| GPS Data Error | Often, civilian-use GPS data is accompanied by |
| | an error estimation, which may be determined by |
| | or in conjunction with the closest sending |
| | satellite |
| Steering Controls | Able to aim the autonomous vehicle to any |
| | direction between −65 degrees to +65 |
| | degrees within a calibrated accuracy of ±0.5 |
| | degrees |
| Steering Wear Data | Indicates hours of use or other indication of |
| | wear on the steering apparatus that could |
| | introduce an additional ±1.5 degrees of |
| | accuracy uncertainty |
| LIDAR Readings | Accurate for range detection (distance) to 2 |
| | centimeters |
| Inertial Measurement | Accurate for acceleration down to 0.05 meters |
| Unit (IMU) Data | per second squared |

As can now be understood, at least for the purpose of collision avoidance by autonomous vehicle 254₂ (shown as vacuum2) while at the same time carrying out the mission (e.g., vacuum the floor without missing a spot), it is strongly desired to have accurate steering so as to just barely avoid collision with stationary obstacle 262. To do so demands accurate steering of the autonomous vehicle, which in turn demands accurate measurements and controls. In this case, the most important factor in collision avoidance is the steering calibration, the accuracy of which in turn is dominantly determined by the steering wear data. As such, what is needed is to be sure that the vehicle's input to the steering controller is going to result in a steering setting within plus or minus 0.5 degrees.

To accomplish this, the portion of the vehicle's model affecting vehicle wear would need to be accurate. Accordingly, the model parameter for steering wear data needs to be updated “just-in-time,” or at least before there is a need for highly accurate steering control. In this case, the semantic of “just-in-time” is characterized by critical distance 256 that defines the minimum distance from an obstacle, outside of which, subsystems for collision avoidance need to be accurate at least to the degree that is needed for maneuvers that carry out the mission at that moment in time (e.g., accounting for wear that may have occurred since the last model update).

As is comprehended by those of skill in the art, the foregoing just-in-time calibration and recalibration need not be performed for every collision avoidance maneuver, but rather only when the accuracy calculations indicate that some specific degree of accuracy is needed for some particular maneuver. That is, and again referring to the juxtaposition of vacuum2, it is entirely possible that collision avoidance calculations (and maneuvers) had been executed within a specific degree of accuracy (e.g., a mission-specific degree of accuracy) well before vacuum2 approaches the critical distance 256.

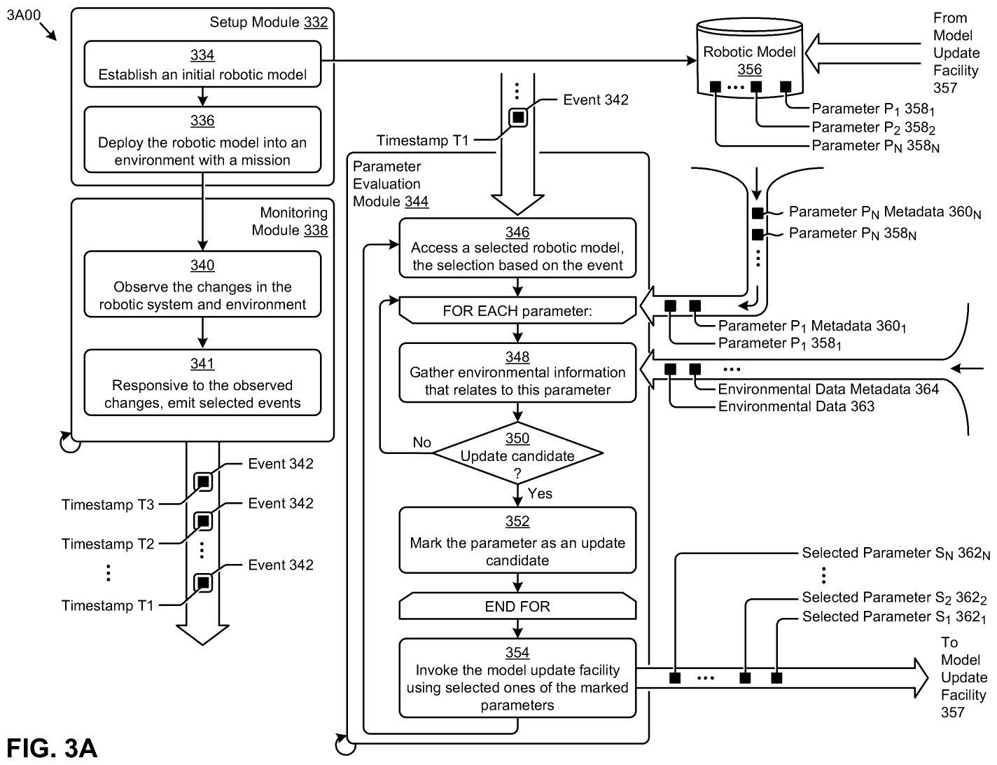

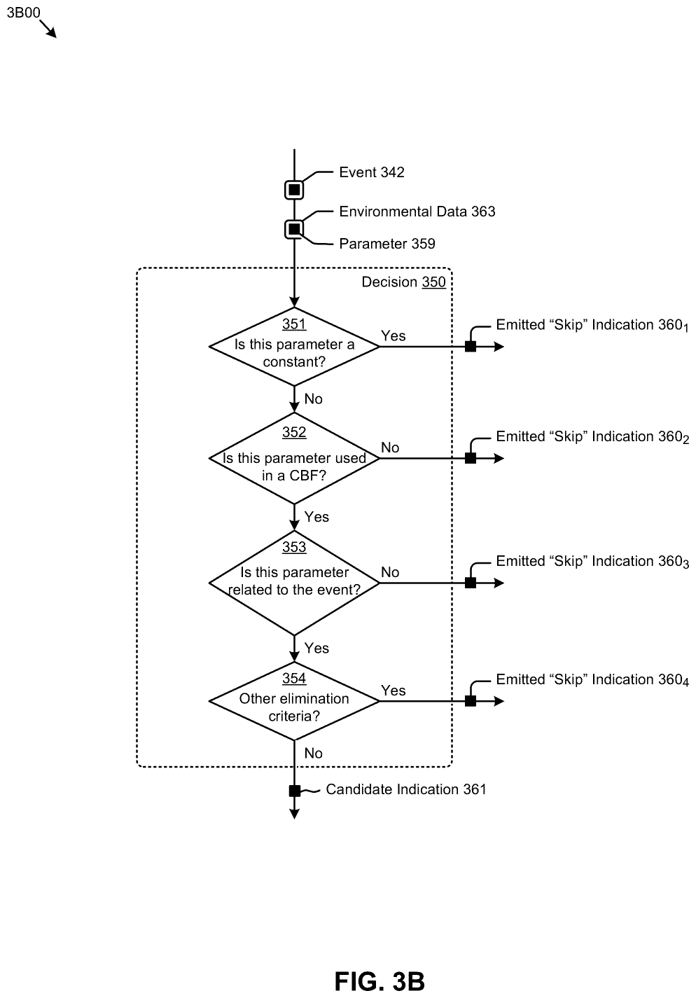

The foregoing discussion of FIG. 2B pertains to merely some possible embodiments and/or ways to implement just-in-time model updates. Many variations are possible, for example, the situation of the foregoing can occur in any environment. Moreover, accomplishment of the foregoing just-in-time model updates can be implemented using computer software and/or hardware that is in turn integrated into a cyber-physical system. One possible implementation involving such computer software and/or hardware is shown and described as pertains to FIG. 3A and FIG. 3B.

FIG. 3A depicts an example cyber-physical system configuration for implementing just-in-time digital control system model update scheduling. As an option, one or more variations of cyber-physical system configuration 3A00 or any aspect thereof may be implemented in the context of the architecture and functionality of the embodiments described herein and/or in any environment.

The figure is being presented to illustrate how a digital control system model update facility can be implemented in a practical cyber-physical system. The configuration depicts (1) a set of setup operations shown as setup module 332, (2) a recurring set of monitoring operations shown as monitoring module 338, and (3) a recurring set of operations shown as parameter evaluation module 344. These three modules interoperate to form a cyber-physical system that implements just-in-time digital control system model updating.

The setup operation of setup module 332 includes establishment of some initial robotic model (step 334), which initial robotic model is initially stored as robotic model 356. This robotic model has any number of model parameters (e.g., parameter P1 358₁, parameter P2 358₂, . . . , parameter P_{N} 358_{N}), which model parameter can be variables or constants or, in some cases, expressions involving either or both variables or constants. Once such an initial model is stored and integrated with a model update facility 357, a cyber-physical system that employs the robotic model can be deployed into an environment and given a specific mission (step 336).

In this example implementation, ongoing monitoring is carried out by monitoring module 338, which in turn observes changes in the robotic system as well as changes in the environment (step 340). A particular observation can be characterized and a respective event (e.g., event 342) is emitted (step 341). On an ongoing basis, further observations are made and further events are emitted, forming a stream of emitted events. In some embodiments, such as depicted in FIG. 3A, a particular event is accompanied by a timestamp (e.g., timestamp T1, timestamp T2, timestamp T3, etc.). Using any known method, an emitted event is delivered to parameter evaluation module 344. It is the role of the parameter evaluation module to determine which, or if, any model parameter is to be considered as a candidate for updating. More specifically, the parameter evaluation module emits selected parameters (e.g., selected parameter S1 362₁, selected parameter S2 362₂, . . . , selected parameter SN 362_{N}), which in turn are delivered to model update facility 357 for consideration upon an invocation of the model parameter facility. Additional operations of the parameter evaluation module are now described.

Responsive to receipt of an event 342 having a corresponding timestamp T1, a determination is made as to which robotic model or models correspond, or at least potentially correspond, in some way to the event. Having determined that, for example, the event 342 with timestamp T1 corresponds to robotic model 356, then the determined robotic model is accessed (step 346). More specifically, the determined robotic model is accessed so as to gather parameters (e.g., the shown parameter P_{N} 358_{N}) and/or parameter metadata (e.g., the shown metadata P_{N} metadata 360_{N}). A particular parameter itself, or possibly a model state variable and its value, is considered in a FOR EACH loop. In some cases, the parameter has associated metadata that is also (or alternatively) considered in a FOR EACH loop. In the specific implementation of FIG. 3A, all parameters (e.g., parameter P₁ 358₁, . . . , parameter P_{N} 358_{N}) and all parameter metadata (e.g., parameter P₁ metadata 360₁, . . . , parameter P_{N} metadata 360_{N}) are considered, however some implementations retrieve parameters and parameter metadata that are deemed to be at least candidates for updates given the then-current environmental conditions.

Now, for each parameter 359 and/or its metadata, applicable environmental information (e.g., environmental data 363 and/or environmental data metadata 364) is gathered (step 348) and then considered (at step 350) with respect to whether or not the then-current situation indicates that the then-current parameter (or its metadata) are to be considered for an update (e.g., a just-in-time update). If so (see the “Yes” branch of decision 350), then processing advances as shown. Otherwise, if the then-current parameter (or its metadata) is deemed to be not a candidate for an update at this moment in time (see the “No branch of decision 350), then the FOR EACH loop advances to the next parameter.

In the situation that the “Yes” branch of decision 350 is taken, that parameter or its metadata are marked (step 352) as an update candidate. After the FOR EACH loop completes or is otherwise terminated, step 354 is entered and all parameters that were marked (e.g., in step 352) are emitted as selected parameters, which in turn are made available to model update facility 357. It should be understood that various embodiments might characterize and pass around parameters and metadata by actual passing of values, or alternatively various alternative embodiments might characterize and pass around parameters and metadata by referring to a location where the parameter, its metadata, and its value are stored. Such a location can be in a subject model itself, or it can be in a data structure separate from the model. In some cases, the foregoing data structure is a part of a database record, which in turn is a part of a database system.

Returning now to the discussion of decision 350, there are many ways to be able to determine whether or not the then-current situation indicates that the then-current parameter and/or its metadata is/are to be considered for an update, some of which are shown and described as pertains to FIG. 3B.

FIG. 3B depicts an example update candidate determination technique as used to implement just-in-time digital control system model updates. As an option, one or more variations of update candidate determination technique 3B00 or any aspect thereof may be implemented in the context of the architecture and functionality of the embodiments described herein and/or in any environment.

The figure is presented to illustrate one way to implement update candidate determination. This particular embodiment involves a sequence of individual binary tests. After performing the sequence of binary tests, if the sequence has not been terminated due to taking any particular binary test's “No” branch, which in turn emits a “Skip” indication such as any one of a plurality of possible “Skip” indications (e.g., skip indication 360₁, skip indication 360₂, skip indication 360₃, skip indication 360₄), then decision 350 emits a “Yes” (e.g., the shown candidate indication 361).

In this particular example implementation, the sequence of individual binary tests comprises, (1) a check to see if this parameter is a constant that should not be changed (step 351), (2) a check to see if this parameter is used in a CBF (step 352), (3) a check to see of this parameter is related to the particular event (step 353) that triggered the processing up to decision 350), and (4) a check to see if there are other elimination criteria (step 354).

In this manner, or in an alternative implementation, the determination as to whether or not a particular model parameter is a candidate for update at the then-current moment in time can be carried out by applying one or more tests to a subject parameter. As is understood by operation of step 353, aspects of the environment, including the aspect of timing of the subject event, are consider in making the determination that a particular variable is to be dealt with “now” or should be “skipped” for consideration at a later time or under a different set of conditions.

The foregoing discussion of FIG. 3B pertains to merely some possible embodiments and/or ways to implement update candidate determination. Many variations are possible, for example, the update candidate determination technique as comprehended in the foregoing can be implemented in any environment or in accordance with any computer module configuration.

### Additional Embodiments of the Disclosure

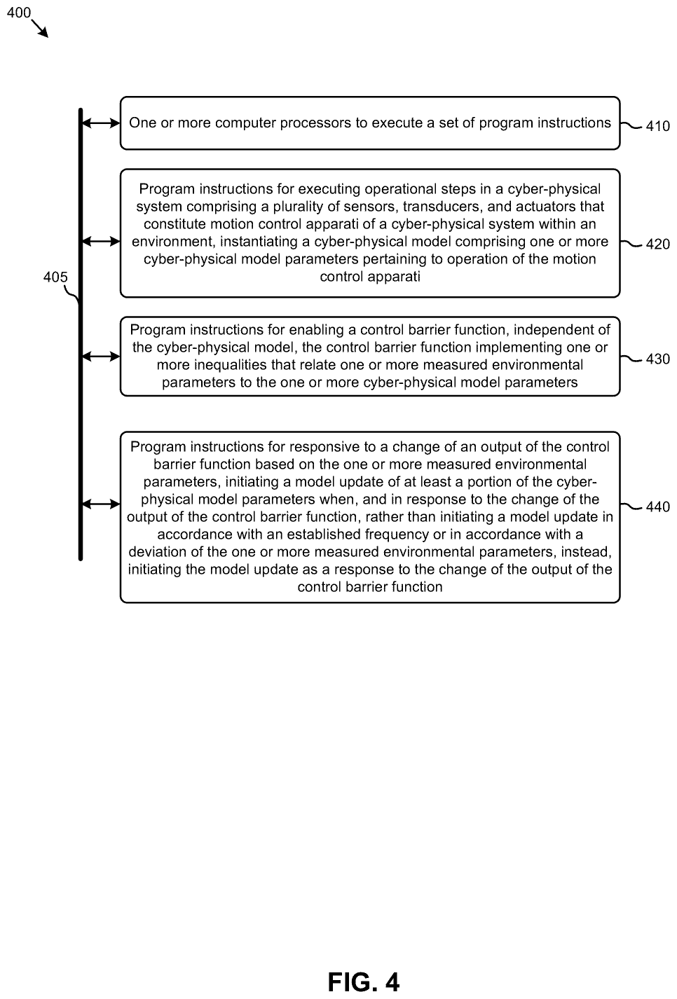

FIG. 4 depicts system 400 as an arrangement of computing modules that are interconnected so as to operate cooperatively to implement certain of the herein-disclosed embodiments. This and other embodiments present particular arrangements of elements that, individually or as combined, serve to form improved technological processes that address the frequency and nature of model updates that might greatly impact safe operation of robotic systems. The partitioning of system 400 is merely illustrative and other partitions are possible. As an option, the system 400 may be implemented in the context of the architecture and functionality of the embodiments described herein. Of course, however, system 400 or any operation therein may be carried out in any desired environment. The system 400 comprises at least one processor and at least one memory, the memory serving to store program instructions corresponding to the operations of the system. As shown, an operation can be implemented in whole or in part using program instructions accessible by a module. The modules are connected to a communication path 405, and any operation can communicate with any other operations over communication path 405. The modules of the system can, individually or in combination, perform method operations within system 400. Any operations performed within system 400 may be performed in any order unless as may be specified in the claims. The shown embodiment implements a portion of a computer system, presented as system 400, comprising one or more computer processors to execute a set of program code instructions (module 410) and modules for accessing memory to hold program code instructions to perform: in a cyber-physical system comprising a plurality of sensors, transducers, and actuators that constitute motion control apparati of a cyber-physical system within an environment, instantiating a cyber-physical model comprising one or more cyber-physical model parameters pertaining to operation of the motion control apparati (module 420); enabling a control barrier function, independent of the cyber-physical model, the control barrier function implementing one or more inequalities that relate one or more measured environmental parameters to the one or more cyber-physical model parameters (module 430); responsive to a change of an output of the control barrier function based on the one or more measured environmental parameters, initiating a model update of at least a portion of the cyber-physical model parameters when, and in response to the change of the output of the control barrier function, rather than initiating a model update in accordance with an established frequency or in accordance with a deviation of the one or more measured environmental parameters, instead, initiating the model update as a response to the change of the output of the control barrier function (module 440).

Variations of the foregoing may include more or fewer of the shown modules. Certain variations may perform more or fewer (or different) steps and/or certain variations may use data elements in more, or in fewer, or in different operations. Still further, some embodiments include variations in the operations performed, and some embodiments include variations of aspects of the data elements used in the operations.

### Additional Practical Application Examples

Strictly as a further teaching of possible embodiments, some systems can be configured to implement a method comprising: (1) identifying a cyber-physical system, and instantiating into the cyber-physical system, a cyber-physical model comprising one or more cyber-physical model parameters pertaining to operation of motion control apparati; (2) enabling, independent of the cyber-physical model, the control barrier function implementing one or more inequalities that relate one or more measured environmental parameters to the one or more cyber-physical model parameters; and (3) responsive to a change of the one or more measured environmental parameters, initiating a model update of at least a portion of the cyber-physical model parameters when, in response to the change of the one or more measured environmental parameters, rather than initiating a model update in accordance with an established frequency, instead, initiating the model update based on the nature and/or extent of the change of the one or more measured environmental parameters and/or, based on a change of an output of one or more control barrier functions.

### System Architecture Overview

### Additional System Architecture Examples

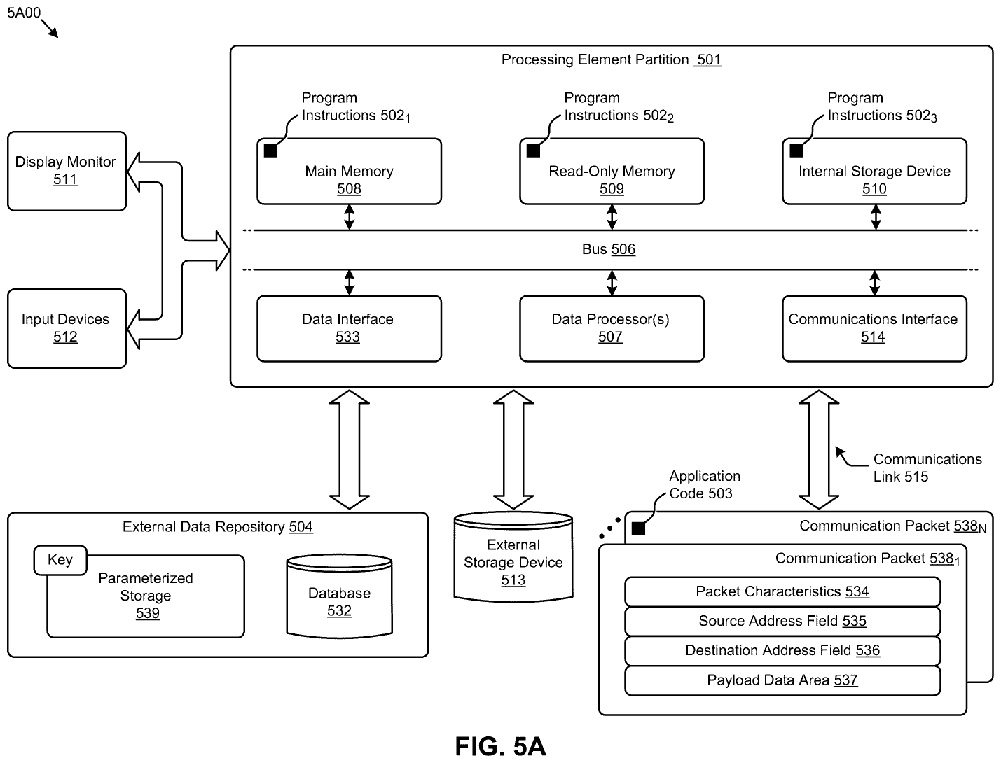

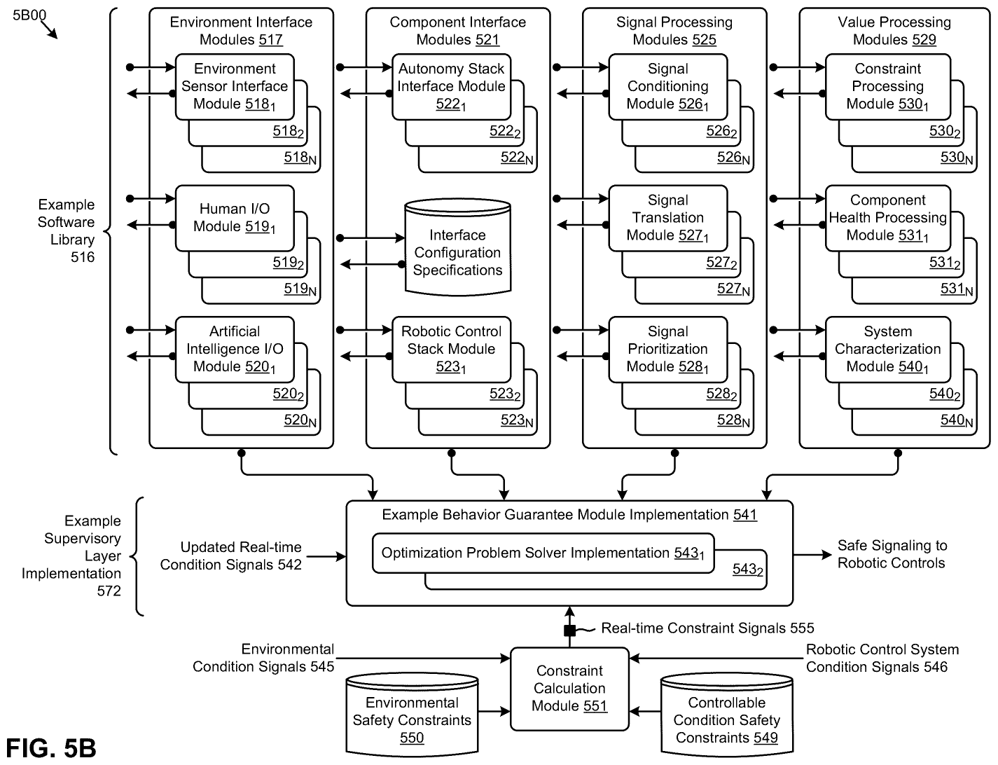

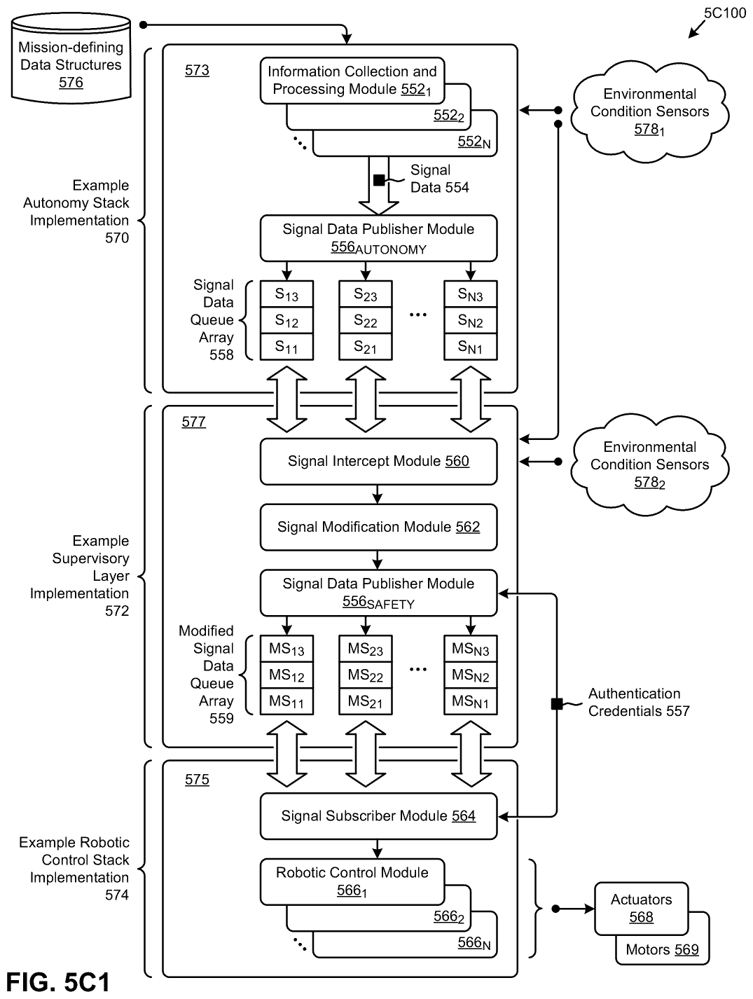

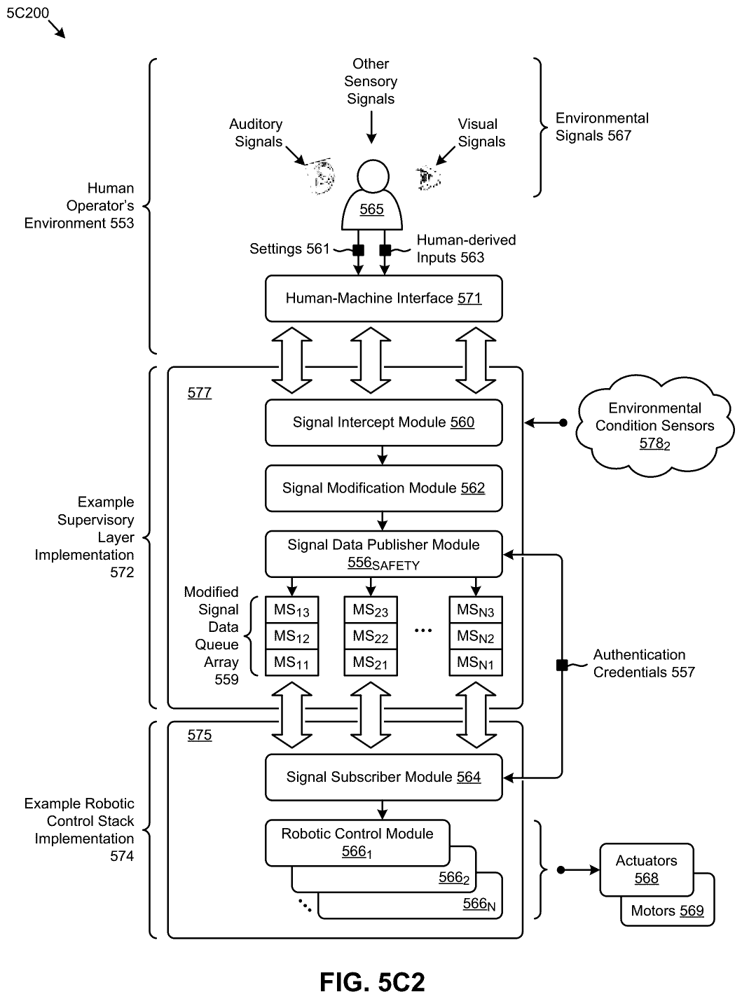

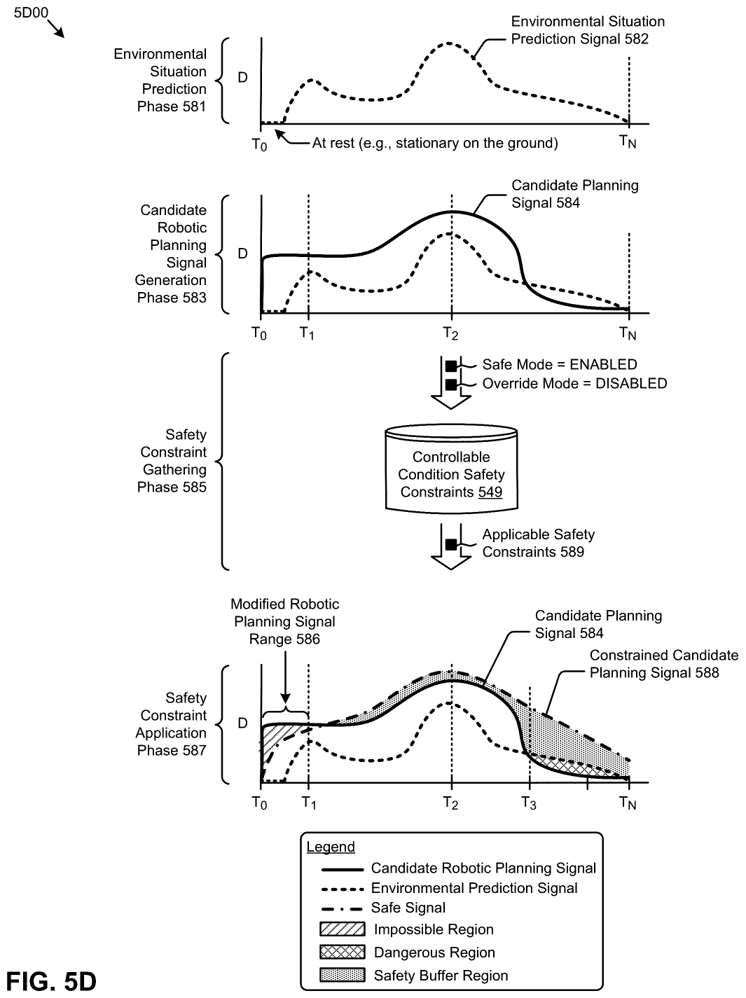

FIG. 5A depicts a block diagram of an instance of a computer system suitable for implementing embodiments of the present disclosure. Computer system 5A00 includes a bus 506 or other communication mechanism for communicating information. The bus interconnects subsystems and devices such as a central processing unit (CPU) or a multi-core CPU (e.g., data processor 507), a system memory (e.g., main memory 508 or an area of random access memory (RAM)), a non-volatile storage device or non-volatile storage area (e.g., read-only memory 509), a storage device that uses semiconductor memory or magnetic or optical technologies (e.g., internal storage device 510), a data interface 533, and a communications interface 514 (e.g., PHY, MAC, Ethernet interface, modem, etc.). The aforementioned components are shown within processing element partition 501, however other partitions are possible. Computer system 5A00 further comprises a display 511 (e.g., CRT or LCD), various input devices 512 (e.g., keyboard, cursor control, etc.), and an external data repository 504.

According to some embodiments of the disclosure, computer system 5A00 performs specific operations by data processor 507 executing one or more sequences of one or more program instructions contained in a memory. Such instructions (e.g., program instructions 502₁, program instructions 502₂, program instructions 502₃, etc.) can be contained in, or can be read into, a storage location or memory from any computer readable/usable storage medium such as a static storage device or a disk drive. The sequences can be organized to be accessed by one or more processing entities configured to execute a single process or the sequences can be configured for execution by multiple concurrently running processing entities. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 5A00 performs specific networking operations using one or more instances of communications interface 514. Instances of communications interface 514 may comprise one or more networking ports that are configurable (e.g., pertaining to speed, protocol, physical layer characteristics, media access characteristics, etc.), and any particular instance of communications interface 514 or port thereto can be configured differently from any other particular instance or port. Portions of a communications protocol can be carried out in whole or in part by any instance of communications interface 514, and data (e.g., packets, data structures, bit fields, etc.) can be positioned in storage locations within communications interface 514 or within system memory, and such data can be accessed (e.g., using random access addressing, or using direct memory access (DMA), etc.) by devices such as data processor 507.

Communications link 515 can be configured to transmit (e.g., send, receive, signal, etc.) any type of communications packets (e.g., communication packet 538₁, . . . , communication packet 538_{N}) comprising any organization of data items. The data items can comprise a payload data area 537, a destination address field 536 (e.g., a destination IP address), a source address field 535 (e.g., a source IP address), and can include various encodings or formatting of bit fields to populate packet characteristics 534. In some cases, the packet characteristics include a version identifier, a packet or payload length, a traffic class, a flow label, etc. In some cases, payload data area 537 can comprise a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software (e.g., instructions stored in/on a non-volatile medium), or hardware that is used to implement all or part of the disclosure.

The terms “computer readable medium” or “computer usable medium” as used herein refer to any medium that participates in providing instructions to data processor 507 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, a flash memory drive, a spinning hard drive, a floppy disk, a flexible disk, magnetic tape, or any other magnetic medium; a CD-ROM or any other optical medium such as punch cards, paper tape, or any other physical medium with patterns of holes; semiconductor memories such as RAM, PROM, EPROM, FLASH-EPROM, or any other memory chip or cartridge; or any other non-transitory computer readable medium. Such data can be stored, for example, in the shown external storage device 513, and/or in any form of an external data repository 504, either of which can be formatted into any one or more storage areas. Certain forms of computer readable media comprise parameterized storage 539 accessible by a key (e.g., filename, table name, block address, offset address, etc.).

Execution of the sequences of instructions to practice certain embodiments of the disclosure are performed by a single instance of a computer system 5A00. According to certain embodiments of the disclosure, two or more instances of computer system 5A00 coupled by a communications link 515 (e.g., LAN, public switched telephone network, or wireless network) may perform the sequence of instructions required to practice embodiments of the disclosure using two or more instances of components of computer system 5A00.

Computer system 5A00 may transmit and receive messages such as data and/or instructions organized into a data structure (e.g., communications packets). The data structure can include program instructions (e.g., application code 503) communicated through communications link 515 and communications interface 514. Received program instructions may be executed by data processor 507 as they are received at the data processor. The program instructions can be copied any number of times (e.g., into an intermediate memory and/or into a CPU cache) for later execution. Computer system 5A00 may communicate through a data interface 533 to a database 532. Data items in a database can be accessed using a primary key (e.g., a relational database primary key) and any number of secondary keys.

Processing element partition 501 is merely one sample partition. Other partitions can include multiple data processors and/or multiple communications interfaces and/or multiple storage devices, etc. within a partition. For example, a partition can bound a multi-core processor (e.g., possibly including embedded or co-located memory), or a partition can bound a computing entity having a plurality of computing elements, any of which computing elements are connected directly or indirectly to a communications link of any sort. Furthermore, a first partition can be configured to communicate to a second partition. A particular first partition and a particular second partition can be congruent (e.g., in a processing element array) or can be different (e.g., comprising disjoint sets of components). A partition can include a single module or a partition can include a plurality of modules.

As used herein, a module refers to any mix of any portions of system memory and any extent of hard-wired circuitry including hard-wired circuitry embodied as all or portions of a data processor 507, which data processor can be used to realize, with or without reliance on the system memory, all or portions of processor-implemented systems or subsystems. Some embodiments of a module include one or more special-purpose hardware components (e.g., sensors, transducers, power control, actuator control logic, etc.). Some embodiments of a module include instructions that are stored in a processor-accessible memory for execution so as to facilitate operational and/or performance characteristics pertaining to fitting a robotic system software stack to interface with an interstitial supervisory layer. A module may include one or more state machines and/or combinational logic used to implement or facilitate the operational and/or performance characteristics pertaining to fitting a robotic system software stack to interface with an interstitial supervisory layer.

Various implementations of database 532 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of fitting a robotic system software stack to interface with an interstitial supervisory layer). Such files, records, or data structures can be brought into and/or stored in volatile or non-volatile memory. The occurrence of, and organization of the foregoing files, records, and data structures improve the way in which the computer stores and retrieves data in memory so as to implement all or portions of a robotic system stack. Strictly as one example, various of the disclosed embodiments improve the way data is accessed when the computer is performing operations pertaining to fitting a robotic system software stack to integrate with an interstitial supervisory layer, and/or for improving the way data is manipulated when performing computerized operations pertaining to robot behavior.

FIG. 5B depicts an environment in which a behavior guarantee module can be implemented. As shown, environment 5B00 includes an example software library 516. Such a library can be situated in a development environment or such a library, either in whole or in part, can be deployed to the field for dynamic linking and loading. Strictly as one example, various components from such a software library can be interfaced together to form variations of a behavior guarantee module. Strictly as an illustration, a behavior guarantee module (e.g., example behavior guarantee module implementation 541) can be constructed of one or more environment interface modules 517, one or more component interface modules 521, one or more signal processing modules 525, and/or any one or more value processing modules 529. The foregoing environment interface modules, component interface modules, signal processing modules, and value processing modules are discussed in further detail hereunder.

As shown, environment interface modules 517 include a selectable set of environment sensor interface modules (e.g., environment sensor interface module 518₁, environment sensor interface module 518₂, . . . , environment sensor interface module 518_{N}; human I/O module 519₁, human I/O module 519₂, . . . , human I/O module 519_{N}; and artificial intelligence I/O module 520₁, artificial intelligence I/O module 520₂, . . . , artificial intelligence I/O module 520_{N}). Any of the foregoing constituents of the environment interface modules can be configured for any particular application. Any combination of environment interface modules can be juxtaposed in any topology and/or in any order or organization.

As shown, component interface modules 521 include a selectable set of component sensor modules (e.g., autonomy stack interface module 522₁, autonomy stack interface module interface module 522₂, . . . , autonomy stack interface module 522_{N}; and robotic control stack module 523₁, robotic control stack module 523₂, . . . , robotic control stack module 523_{N}). Any of the foregoing constituents of the component interface modules can be configured for any particular application. The component interface modules may further include a database or other storage of interface configuration specifications. Any combination of component interface modules can be juxtaposed in any manner.

As shown, signal processing modules 525 include a selectable set of various signal processing modules (e.g., signal conditioning module 526₁, signal conditioning module 526₂, . . . , signal conditioning module 526_{N}; signal translation module 527₁, signal translation module 527₂, . . . , signal translation module 527_{N}; and signal prioritization module 528₁, signal prioritization module 528₂, . . . , signal prioritization module 528_{N}). Any of the foregoing constituents of the signal processing modules can be configured for any particular application. Any combination of signal processing modules can be juxtaposed into any organization.

As shown, value processing modules 529 include a selectable set of various value processing modules (e.g., constraint processing module 530₁, constraint processing module 530₂, constraint processing module 530_{N}; component health processing module 531₁, component health processing module 531₂, . . . , component health processing module 531_{N}; and system characterization module 540₁, system characterization module 540₂, . . . , system characterization module 540_{N}). Any of the foregoing constituents of the value processing modules can be configured for any particular application. Any combination of value processing modules can be juxtaposed into any organization. Moreover, in some settings, any of the foregoing modules and specifications can be included (or excluded) in any particular deployment.

The particular deployment shown includes an example supervisory layer implementation 572. Such a supervisory layer may include one or more implementations of a behavior guarantee module (e.g., the shown example behavior guarantee module implementation), which in turn may include one or more optimization problem solver (e.g., optimization problem solver implementation 543₁, and optimization problem solver implementation 543₂). A behavior guarantee module can be configured with any manner of environment interface modules, which in turn are configured to be able receive an ongoing stream of updated real-time condition signals 542. Those updated real-time condition signals can be combined with an ongoing stream of real-time constraint signals 555 to express a then-current safe operation requirement into codification that is in a form of a problem that can be solved by one or more optimization problem solvers.

The ongoing stream of real-time constraint signals 555 can derive from any combination of environmental safety constraints 550 and/or any combination of controllable condition safety constraints 549. In some cases, the ongoing stream of real-time constraint signals is output from a constraint calculation module 551. Such a constraint calculation module can be configured to process any combination of environmental condition signals 545 and/or any combination of robotic control system condition signals 546.

In many cases environmental condition signals can change in response to signals that are sent to the robotic controls. For example, consider the scenario where there is an obstacle (e.g., a stationary object or a moving object) on the trajectory or path of a movable mechanical device (e.g., a robotic manipulator, an autonomous robotic vehicle, an autonomous aerial drone, etc.). Supposing that the controllable condition safety constraints include a constraint that has the semantics of “stay at least 10 feet from any obstacle,” then the path of the movable mechanical device can be changed so as to “veer away” from the obstacle. Once the movable mechanical device has maneuvered away, the newly updated environmental condition signals might indicate that there is no longer an obstacle in the path (or close to the path) of the movable mechanical device. Now, further consider that the “veer away” action was taken because of the aforementioned environmental safety constraint. However, it might be that there is a currently in force controllable condition safety constraint 549 that has the semantics of “stay at least 20 feet from any obstacle,” in which case, when considering both the environmental safety constraints as well as the controllable condition safety condition constraints, the constraint calculation module might form a real-time constraint signal that is more restrictive (e.g., safer) than when considering environmental safety constraints alone.

In exemplary scenarios, real-time candidate robotic planning signals are considered with respect to real-time constraints (e.g., environmental safety constraints, controllable condition safety constraints, etc.) so as to produce safe real-time signals, which are then provided to various robotic control systems. More particularly, candidate robotic planning signals corresponding to a robotic operation or a manipulator movement, or a robotic vehicle maneuver can be modified in accordance with the foregoing techniques so as to generate real-time robotic control signals that are deemed to be safe.

Further details regarding general approaches to producing safe robotic vehicle maneuvers are described in U.S. application Ser. No. 18/324,042 titled “SYSTEMS AND METHODS FOR HIGH-SPEED GEOFENCING” filed on May 25, 2023, which is hereby incorporated by reference in its entirety.

There may be many other scenarios and many other types of environmental safety constraints 550 as well as many other types of controllable condition safety constraints 549. For example, it can happen that a particular controllable condition safety constraint might be less constraining than a corresponding environmental safety constraint. The optimization problem solvers would solve for optimal solutions that still satisfy the then-current safety constraints. As such, it can happen that optimal safe robotic behavior is not necessarily any less optimal in any regard than optimal robotic behavior even in the absence of any given controllable condition safety constraints. On the other hand, it frequently happens that observance of controllable condition safety constraints overrides mere environmental safety constraints so as to result in safe behavior of the robot.

The supervisory layer implementation of FIG. 5B is merely one example as is applicable to the shown example environment. A supervisory layer can be implemented in many alternative environments, some of which such alternative environments are shown and described as pertains to FIG. 5C1 and FIG. 5C2.

FIG. 5C1 depicts a block diagram of an interstitially situated supervisory layer. More specifically, FIG. 5C1 depicts block diagram 5C100 that includes a safety module 577 (e.g., comprising example supervisory layer implementation 572) that is situated between a planning module 573 (e.g., comprising example autonomy stack implementation 570) and a kinetic control module 575 (e.g., comprising example robotic control stack implementation 574).

In this juxtaposition, the example supervisory layer implementation can be configured to (1) intercept signals from the example autonomy stack implementation, (2) process such intercepted signals, and (3) provide modified versions of the intercepted signals to downstream processing. Additionally or alternatively, the example supervisory layer implementation 572 can be configured to receive and process signals from any one or more of a variety of environmental sources (e.g., from environmental condition sensors 578₁ and/or from environmental condition sensors 578₂).

In this illustrative example, downstream processing includes processing of the modified versions of the intercepted signals (e.g., by robotic control module 566₁, robotic control module 566₂, . . . , robotic control module 566_{N}) so as to provide signals to any of a plurality of motors 569 and/or actuators 568.

In this manner, the interstitially situated supervisory layer can support any one or more robotic control applications in various settings (e.g., involving robotic terrestrial vehicle control, manufacturing floor robot control, unmanned aerial vehicle control, and/or anthropomorphic robot control, etc.). In this particular architecture, example supervisory layer implementation 572 includes a signal intercept module 560, a signal modification module 562, and a signal data publisher module 556_{SAFETY}. The signal data publisher module 556_{SAFETY} is configured to enter modified versions of the intercepted signals (or portions thereof) into one or more modified signal queues, as exemplified by modified signal data queue array 559. As shown, the contents of the constituent queues of the modified signal data queue array (e.g., modified signal data queue entry MS₁₁, modified signal data queue entry MS₁₂, modified signal data queue entry MS₁₃, modified signal data queue entry MS₂₁, modified signal data queue entry MS₂₂, modified signal data queue entry MS₂₃, . . . , modified signal data queue entry MS_{N1}, modified signal data queue entry MS_{N2}, modified signal data queue entry MS_{N3}) are made accessible to downstream processing. Strictly as one possible implementation, access to the contents of the constituent queues of the modified signal data queue array is facilitated by one or more subscriber modules. The shown example is security hardened by virtue of the communication protocol between shown signal subscriber module 564 and signal data publisher module 556_{SAFETY}, where such a communication protocol serves to securely communicate information (e.g., authentication credentials 557) between the modules.

The shown example robotic control stack implementation 574 includes a signal subscriber module, shown as signal subscriber module 564, which signal subscriber module can be configured to access entries that are stored in any one or more queues of the modified signal data queue array 559. In some cases, a signal subscriber module can be configured to access entries according to a first-in-first-out (FIFO) regime, and/or a signal subscriber module can be configured to access entries according to a last-in-first-out (LIFO) regime, and/or a signal subscriber module can be configured to access entries according to a random access regime, in which random access regime a subscriber can access entries from any position of any one or more queues of the modified signal data queue array.

Variations of the shown supervisory layer can be deployed in any environment that corresponds to any particular mission. Merely to illustrate one possible implementation, the environment of FIG. 5C1 includes a repository of mission-defining data structures 576. Particular types of data that might be populated into the foregoing mission-defining data structures may serve to inform various respective information collection and processing modules of an autonomy stack (e.g., information collection and processing module 552₁, information collection and processing module 552₂, . . . , information collection and processing module 552_{N}). These information collection and processing modules take in information from the environment (e.g., via environmental condition sensors 578₁) and process such environmental information in conjunction with data of the of mission-defining data structures so as to produce processed information in the form of signal data 554, which processed information is made available for publication to and access by any types of subscribers. As shown, a signal data publisher module 556_{AUTONOMY} is interfaced with signal data queue array 558 to provide access to signal data (e.g., as may be present in signal queue entry S₁₁, signal data queue entry S₁₂, signal data queue entry S₁₃, signal data queue entry S₂₁, signal data queue entry S₂₂, signal data queue entry S₂₃, and signal data queue entry S_{N1}, signal data queue entry S_{N2}, . . . , signal data queue entry S_{N3}). Any signal data queue entry within the individual constituent queues of the signal data queue array 558 are accessible by signal intercept module 560. For security purposes, signal intercept module 560 may interact with signal data publisher module 556_{AUTONOMY} so as to establish authenticated and secure access to the content of the signal data queue array.

The foregoing example of FIG. 5C1 exemplifies an embodiment where the autonomy stack or its constituent autonomy agents publish signal data in a manner that the supervisory layer can intercept and process such signals. However there are situations where, rather than having an autonomy stack that generates signals destined for the robotic control stack, instead, a human operator generates signals destined for the robotic control stack. In similar fashion to how an interstitially situated supervisory layer can generate safe robotic control signals based on instructions from an autonomy stack, some embodiments generate safe robotic control signals based on instructions from a human operator. One example embodiment involving generating safe robotic control signals based on instructions from a human operator is shown and described as pertains to FIG. 5C2.

FIG. 5C2 depicts a block diagram involving a human operator's safe manipulation of a robotic control system. More specifically, FIG. 5C2 depicts block diagram 5C200 that includes an example supervisory layer implementation 572 that is situated between an example human operators' environment 553 and an example robotic control stack implementation 574.

This figure is being presented to illustrate how a supervisory layer can produce safe robotic control system signals based on signals received from a human operator. In this particular example, operator 565 uses his or her senses to process any of a variety of environmental signals 567. As shown, the user processes visual signals, auditory signals and other sensory signals, and then, using human faculties, resolves such sensory signals into man-machine interface inputs. The shown human-machine interface 571 can accept any manner of real-time inputs (e.g., human-derived inputs 563) as well as any manner of settings 561 that the user establishes. In some cases, a particular instance of a human-machine interface receives information from a robotic control stack, which information can be used to calibrate the human-machine interface. Such calibration can take place statically (e.g., when the user is not actively providing human-derived signals to the human-machine interface), or such calibration can take place dynamically (e.g., during time periods when the user is actively providing human-derived signals to the human-machine interface).

As is known by those of ordinary skill in the art, a human operator can be a system's “own worst enemy.” That is, given a set of controls, and in absence of any modules that constrain or otherwise modify human inputs, a human operator, in spite of any amount of training and scenario simulation practice, can operate a robot in an unsafe manner. This of course is to be avoided. The foregoing supervisory layer serves to constrain or otherwise modify human inputs so as to guarantee safe operations with respect to all known environmental conditions. Strictly as one example, a supervisory layer can generate safe signals that govern speed of a manipulation and/or a supervisory layer can generate safe signals that govern the path taken (and safe space buffer required) by any articulation of the robot. There are many ways to implement safe signal generation and governance of a robotic system. On possible approach is shown and described as pertains to FIG. 5D.

FIG. 5D depicts a safe signal generation technique. The safe signal generation technique 5D00 is shown as a progression through several phases. In a first phase (e.g., the shown environmental situation prediction phase 581), an environmental situation prediction signal 582 is generated. In this example, the environmental situation prediction signal ranges from time=T₀ to time=T_{N}. The ordinate corresponds to the distance D that a robot is, or is predicted to be, from the nearest environmental features (e.g., the ground or obstacles that might be in the robot's path). In this particular scenario, the robot is initially at rest on the ground, traverses through a path, and comes again to a resting point on the ground.

In a second phase (e.g., the shown candidate robotic planning signal generation phase 583), a candidate planning signal 584 is generated. This candidate planning signal corresponds to the real-time signals that would need to be provided to the robotic control system in order to carry out a robotic operation or maneuver. In the illustrative example, the candidate planning signal already has some headroom or margin of error. Specifically, the candidate planning signal 584 corresponds to controlling the robot to maintain an even greater distance away from obstacles in the environment as was predicted in the environmental situation prediction phase 581. This is evident in the plot in that the candidate planning signal is plotted as maintaining an even greater distance away from any obstacle than is plotted by the environmental prediction signal. A candidate planning signal 584 may have within its range any number of local maxima and/or other types of critical points. In the shown example, there is a local maximum at time=T₁ and another local maximum at time=T₂.

After a candidate planning signal has been generated, possibly under control of an autonomy stack, the safe signal generation technique proceeds to a third phase (e.g., the shown safety constraint gathering phase 585) in which phase various safety constraints are gathered (e.g., from the shown controllable condition safety constraints 549). The specific constraints that are gathered (e.g., applicable safety constraints 589) may depend on whether or not a safe mode indication is enabled and/or whether an override mode indication is enabled, and may further depend on—and correspond to—any one or more of the then-current conditions. For example, if the currently under consideration maneuver requires movement through three dimensional space, then safety constraints corresponding to an X direction as well as safety constraints corresponding to a Y direction as well as safety constraints corresponding to a Z direction are gathered. Furthermore, in this safety constraint gathering phase, constraints pertaining to the mechanisms of the robotic control system are also gathered for potential use in the safety constraint application phase 587.

In most situations, accomplishment of some particular robotic maneuver involves control of actuators and/or control of motors. The operational characteristics of such actuators and/or motors is to be considered in the context of safety constraints. More specifically, application of any set of gathered safety constraints should not result in exceeding the operational capabilities of the robotic control mechanisms (e.g., actuators and/or motors). As an example, one way to avoid an obstacle is to “quickly maneuver” away from the obstacle when approaching it. However, in real robotic systems involving real motors and real actuators, operations intended to “quickly maneuver” are limited by characteristics that are designed into or inherent in the underlying robotic control system. Knowledge of such limitations are often pertinent to safe operation. To further explain, one way to “quickly maneuver” away from the obstacle so as to avoid a collision is to apply a great deal of acceleration in one or more directions that maneuver around or away from the obstacle. However, the amount of force needed to “quickly maneuver” might exceed the capabilities of the robotic control system. As such, safe operation needs to consider the limitations of the robotic control system when applying constraints.

After gathering applicable safety constraints in the safety constraint gathering phase 585, those gathered constraints can be applied. This is shown in FIG. 5D as a fourth phase, namely safety constraint application phase 587. In this phase, wrong or dangerous or practicably impossible robotic control signals are modified so as to operate within a safe robotic control regime. As can be seen, the transformation of the candidate planning signal 584 into the shown constrained candidate planning signal 588 serves to address any portions of the candidate planning signal 584 that were wrong or dangerous or practicably impossible, or otherwise unsafe. In the example signal transformation of FIG. 5D, the safe robotic control signal has some portions (e.g., within the impossible region) where the values in those portions correspond to lesser values than respective portions of the corresponding candidate planning signal (e.g., the portions as shown in the range of time=T₀ to time=T₁). Further, in the example signal transformation of FIG. 5D, the safe robotic control signal has some portions where the values in those portions correspond to higher values than respective points of the corresponding candidate planning signal (e.g., as shown in the range time=T₁ to time=T_{N}). In the example signal transformation of FIG. 5D, the safe robotic control signal has some portions where the values in those portions correspond to values that correct errors in respective points of the corresponding candidate planning signal (e.g., as shown in the range from time=T₃ to time=T_{N}).

In some cases, a particular incoming candidate planning signal is deemed to be safe even as unmodified (e.g., when the particular incoming candidate planning signal satisfies all applicable constraints). In other cases, a particular incoming candidate planning signal would need to be modified in order to be safe. In this latter case, any number of points and/or any number of ranges of points along the particular incoming candidate planning signal are modified to satisfy all applicable constraints. In the example shown, a particular range of points along the candidate planning signal 584, shown here as modified robotic planning signal range 586, are modified so as to send a ramped control signal (e.g., ramped during the time period from time=T₀ and time=T₁) to the robotic control system, rather than to apply an impulse signal to the robotic control system.

Of course the foregoing illustrates merely one type of situation. Other situations abound where some aspect of, or information from, the robotic control stack is used to inform how a candidate planning signal should be modified in order to produce a safe robotic control signal.

The foregoing techniques for guaranteeing safe behavior can be implemented in any environment and/or in any robotic system and/or in any deployment scenario. As a first example scenario, consider the situation where a first vehicle is approaching a second vehicle (e.g., in a speed/distance scenario where the first vehicle is a few seconds away from rear-ending the second vehicle. Now, assume unskilled driving where the driver accidentally presses the accelerator rather than the brake. In this situation, one or more safe behavior guarantee modules had prospectively characterized exactly how quickly the car is able to decelerate including consideration of characteristics of the vehicle's braking system, characteristics of the road, consideration of characteristics such as the weight of the vehicle and driver, as well as consideration of how much distance is covered during a braking maneuver. The one or more safe behavior guarantee modules calculates and actuates safe signals such that prior to a collision, the safe signals cause the first vehicle to decelerate (e.g., by applying brakes) on behalf of the driver. As a second example scenario, consider the situation where a robotic arm is repositioning a mechanical member from one position to another position. During the repositioning, a human being walks into the general proximity of the robotic arm. This presents a dangerous condition for the human being. As such, one or more safe behavior guarantee modules are configured to calculate safe parameters based on (1) the velocity (path and speed) of the human walking towards the robotic arm, as well as (2) how quickly the robotic arm can decelerate and stop. The one or more safe behavior guarantee modules use both pieces of information to intercept any unsafe reference signals that were intended to be sent to the robotic arm's actuators and motors. In addition to merely intercepting unsafe signals before they are sent to the robotic arm's actuators and motors, calculated signals are sent to the robotic arm's actuators and motors. As a third example scenario, consider the situation where a semi-autonomous mobile robot is moving around a factory floor. A maximum speed parameter indicates that the mobile robot is limited to less than 2 m/s speed. Now, if the operator instructs the robot accelerate to a speed of 3 m/s., then one or more safe behavior guarantee modules will intervene to intercept signals corresponding to the operator instructions and modify them down to the safe maximum speed of 2 m/s. This particular example might not require characterizing the dynamics of the semi-autonomous mobile robot since, if there is sufficiently accurate absolute position sensor data available (e.g., hi-resolution GPS data) the speed can be limited to the specified 2 m/s.

The foregoing discussion is presented here merely for illustrative purposes. The presence or absence of any particular feature in the drawings is not intended to be limiting. Moreover, the extent or scope of discussion of any particular feature or the absence of discussion of any particular feature is not intended to be limiting.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts to implement a cyber-physical safety system, the acts comprising:
in a cyber-physical system comprising a plurality of sensors, transducers, and actuators that constitute motion control apparati of a cyber-physical system within an environment, instantiating a cyber-physical model comprising one or more cyber-physical model parameters pertaining to operation of the motion control apparati;
enabling a control barrier function, independent of the cyber-physical model, the control barrier function implementing one or more inequalities that relate one or more measured environmental parameters to the one or more cyber-physical model parameters; and
responsive to a change of an output of the control barrier function based on the one or more measured environmental parameters, initiating a model update of at least a portion of the cyber-physical model parameters when:
in response to the change of the output of the control barrier function, rather than initiating a model update in accordance with an established frequency or in accordance with a deviation of the one or more measured environmental parameters, instead, initiating the model update as a response to the change of the output of the control barrier function.

2. The non-transitory computer readable medium of claim 1, further comprising instructions which, when stored in memory and executed by the processor cause the processor to perform further acts of,
determining a subset of the one or more cyber-physical model parameters that are not used in the inequalities; and
modifying at least one of the one or more cyber-physical model parameters without modifying the cyber-physical model parameters that are not used in the inequalities.

3. The non-transitory computer readable medium of claim 1, wherein a then-current condition or event of the environment is different from a previously-current condition or event of the environment.

4. The non-transitory computer readable medium of claim 1, wherein the model update of at the at least one of the one or more cyber-physical model parameters is responsive breach of a threshold.

5. The non-transitory computer readable medium of claim 4, wherein the threshold is a predetermined amount.

6. The non-transitory computer readable medium of claim 4, wherein the threshold is a dynamically determined amount.

7. The non-transitory computer readable medium of claim 1, wherein a deviation of the one or more measured environmental parameters is a pre-determined threshold value.

8. A method to implement a cyber-physical safety system, the method comprising:
in a cyber-physical system comprising a plurality of sensors, transducers, and actuators that constitute motion control apparati of a cyber-physical system within an environment, instantiating a cyber-physical model comprising one or more cyber-physical model parameters pertaining to operation of the motion control apparati;
enabling a control barrier function, independent of the cyber-physical model, the control barrier function implementing one or more inequalities that relate one or more measured environmental parameters to the one or more cyber-physical model parameters; and
responsive to a change of an output of the control barrier function based on the one or more measured environmental parameters, initiating a model update of at least a portion of the cyber-physical model parameters when:
in response to the change of the output of the control barrier function, rather than initiating a model update in accordance with an established frequency or in accordance with a deviation of the one or more measured environmental parameters, instead, initiating the model update as a response to the change of the output of the control barrier function.

9. The method of claim 8, further comprising,
determining a subset of the one or more cyber-physical model parameters that are not used in the inequalities; and
modifying at least one of the one or more cyber-physical model parameters without modifying the cyber-physical model parameters that are not used in the inequalities.

10. The method of claim 8, wherein a then-current condition or event of the environment is different from a previously-current condition or event of the environment.

11. The method of claim 8, wherein the model update of at the at least one of the one or more cyber-physical model parameters is responsive breach of a threshold.

12. The method of claim 11, wherein the threshold is a predetermined amount.

13. The method of claim 11, wherein the threshold is a dynamically determined amount.

14. The method of claim 8, wherein a deviation of the one or more measured environmental parameters is a pre-determined threshold value.

15. A system to implement a cyber-physical safety system, the system comprising:
a storage medium having stored thereon a sequence of instructions; and
a processor that executes the sequence of instructions to cause the processor to perform acts comprising,
in a cyber-physical system comprising a plurality of sensors, transducers, and actuators that constitute motion control apparati of a cyber-physical system within an environment, instantiating a cyber-physical model comprising one or more cyber-physical model parameters pertaining to operation of the motion control apparati;
enabling a control barrier function, independent of the cyber-physical model, the control barrier function implementing one or more inequalities that relate one or more measured environmental parameters to the one or more cyber-physical model parameters; and
responsive to a change of an output of the control barrier function based on the one or more measured environmental parameters, initiating a model update of at least a portion of the cyber-physical model parameters when:
in response to the change of the output of the control barrier function, rather than initiating a model update in accordance with an established frequency or in accordance with a deviation of the one or more measured environmental parameters, instead, initiating the model update as a response to the change of the output of the control barrier function.

16. The system of claim 15, further comprising instructions which, when stored in memory and executed by the processor cause the processor to perform further acts of,
determining a subset of the one or more cyber-physical model parameters that are not used in the inequalities; and
modifying at least one of the one or more cyber-physical model parameters without modifying the cyber-physical model parameters that are not used in the inequalities.

17. The system of claim 15, wherein a then-current condition or event of the environment is different from a previously-current condition or event of the environment.

18. The system of claim 15, wherein the model update of at the at least one of the one or more cyber-physical model parameters is responsive breach of a threshold.

19. The system of claim 18, wherein the threshold is a predetermined amount.

20. The system of claim 18, wherein the threshold is a dynamically determined amount.

21. The system of claim 15, wherein a deviation of the one or more measured environmental parameters is a pre-determined threshold value.

22. A safety system deployed into an environment, the safety system comprising:
a plurality of sensors, transducers, and actuators that constitute motion control apparati of a cyber-physical system that interfaces with the environment;
a cyber-physical model, the cyber-physical model comprising one or more cyber-physical model parameters pertaining to operation of the motion control apparati;
a control barrier function module, independent of the cyber-physical model and implementing one or more inequalities that relate one or more measured environmental parameters to the one or more cyber-physical model parameters; and
a computing element that, in response to occurrence of a then-current condition or event of the environment, causes,
determination of a subset of the one or more cyber-physical model parameters that are not used in the inequalities; and
modification of at least one of the one or more cyber-physical model parameters without modifying the cyber-physical model parameters of the subset of the one or more cyber-physical model parameters that are not used in the inequalities.

23. The safety system of claim 22, wherein the then-current condition or event of the environment is different from a previously-current condition or event of the environment.

24. The safety system of claim 22, wherein the modification of at the least one of the one or more cyber-physical model parameters is responsive breach of a threshold.

25. The safety system of claim 24, wherein the threshold is a predetermined amount.

26. The safety system of claim 25, wherein a pre-determined deviation of the one or more measured environmental parameters is a threshold value.

27. The safety system of claim 24, wherein the threshold is a dynamically determined amount.
